(19) United States
(12) Patent Application Publication
(10) Pub. No.: US 2015/0193698 A1
(43) Pub. Date: Jul. 9, 2015

(54) DATA PROCESSING DEVICE

(71) Applicant: NEC Corporation, Tokyo (JP)

(72) Inventors: Nobutatsu NAKAMURA, Tokyo (JP); Yoshihiro Kanna, Tokyo (JP)

(73) Assignee: NEC Corporation

(21) Appl. No.: 14/590,097

(22) Filed: Jan. 6, 2015

(30) Foreign Application Priority Data
Jan. 6, 2014 (JP) 2014-000158

(51) Int. Cl. G06N 99/00; G06N 5/04

(52) U.S. Cl. CPC G06N 99/005; G06N 5/04

(57) ABSTRACT

A data processing device includes a storage part, a machine learning part, a classifying part, and a user interface part. The storage part stores a plurality of teacher data each including content and a label representing a category to which the content belongs. The machine learning part generates a classification model by using the plurality of teacher data. The classifying part determines the category that the content of each of the plurality of teacher data belongs by using the classification model. The user interface part causes a display part to display the content and label of the teacher data and the category that the content belongs determined by the classifying part.

### INCORPORATION BY REFERENCE

This application is based upon and claims the benefit of priority from Japanese patent application No. 2014-000158, filed on Jan. 6, 2014, the disclosure of which is incorporated herein in its entirety by reference.

### TECHNICAL FIELD

The present invention relates to a data processing device and method for supporting a user's operation to generate teacher data used for machine learning, and also relates to a computer program for the same.

### BACKGROUND ART

In the fields of video monitoring, video analysis and the like, mechanical classification of content like image data into some categories is conducted by using a data processing device. For example, it is proposed as a first related technique relating to the present invention to, in the process of manufacturing a board such as a printed wiring board, analyze data of a captured image of a board having a defect and classify the data into a category depending on the type of the defect (see Patent Document 1, for example). In order to make a data processing device perform such classification, there is a need to make the data processing device learn. Then, in order to make the data processing device learn, teacher data is necessary. Teacher data is a case of a pair (an input/output pair) of content like image data as an input and the kind of a category as an output.

Basically, generation of teacher data is manually conducted. However, generation of adequate teacher data requires much time and labor. Thus, some devices and systems for supporting manual generation of teacher data are proposed. For example, it is proposed as a second related technique relating to the present invention to, for generation of teacher data necessary for classification into a category depending on the type of the defect mentioned above, display the image of the defect of the printed wiring board on a display and accept an input of a category that the user thinks this displayed defect image belongs to through a keyboard and a mouse (see Patent Document 2, for example). In more detail, in the second related technique, defect images are displayed in array based on the sizes of defects and the imaging positions on a test objet. The displayed defect images include a defect image which is already provided with a category and a defect image which is not provided with a category yet, and the outline of the defect image provided with a category is displayed in a color corresponding to the category. Moreover, a statistical value of a feature value of a defect image belonging to a category, data acquired in a test, an image which is already subjected to image processing, an image which is similar to or not similar to a defect image of the classification target, a region in which calculation of a feature value is performed in a defect image of the classification target, and so on are displayed as necessary in response to an operator's operation.

[Patent Document 1] Japanese Unexamined Patent Application Publication No. JP-A 2011-158373
[Patent Document 2] Japanese Unexamined Patent Application Publication No. JP-A 2003-317082

In a case where teacher data used for learning is not adequate, the learning is not properly performed, and the classification accuracy of the data processing device decreases. However, manually generated teacher data is likely to contain inadequate teacher data due to a human error though it is a very small part. Then, once inadequate teacher data is mixed in, it is not easy to find it afterward.

For example, as shown in the second related technique, it is supposed to display a defect image to which a category is already given onto a display together with identification of the given category so that an operator rechecks the correctness of the category given to the defect image. However, finding inadequate teacher data from among a number of teacher data by such a method requires the user to spend much time and effort.

### SUMMARY

An object of the present invention is to provide a data processing device which solves the abovementioned problem, that is, a problem that it is a large burden for the user to recheck whether or not teacher data is adequate.

A data processing device according to a first aspect of the present invention includes:

a storage part storing a plurality of teacher data including respective contents and respective labels, the labels representing categories to which the contents belong;

a machine learning part generating a classification model by using the plurality of teacher data;

a classifying part determining a category to which a content of each of the plurality of teacher data belongs, by using the classification model; and

a user interface part causing a display part to display the content and a label of each of the plurality of teacher data and the category that the content belongs determined by the classifying part.

A data processing method according to a second aspect of the present invention is a data processing method executed by a data processing device including a storage part storing a plurality of teacher data including respective contents and respective labels, the labels representing categories to which the contents belong, the data processing method including:

generating a classification model by using the plurality of teacher data;

determining a category to which a content of each of the plurality of teacher data belongs, by using the classification model; and

causing a display part to display the content and a label of each of the plurality of teacher data and the determined category that the content belongs.

A program according to a third aspect of the present invention is a computer program including instructions for causing a computer, which includes a storage part storing a plurality of teacher data including respective contents and respective labels representing categories to which the contents belong, to function as:

a machine learning part generating a classification model by using the plurality of teacher data;

a classifying part determining a category to which a content of each of the plurality of teacher data belongs, by using the classification model; and

a user interface part causing a display part to display the content and a label of each of the plurality of teacher data and the category that the content belongs determined by the classifying part.

With the abovementioned configurations, the present invention can reduce the user's burden of rechecking whether or not teacher data is adequate.

### BRIEF DESCRIPTION OF DRAWINGS

FIG. 1 is a block diagram of a first exemplary embodiment of the present invention;

FIG. 2 is a diagram showing an example of the configuration of teacher data in the first exemplary embodiment of the present invention;

FIG. 3 is a diagram showing an example of the configuration of a classification result in the first exemplary embodiment of the present invention;

FIG. 4 is a flowchart showing an example of the behavior of a machine learning part in the first exemplary embodiment of the present invention;

FIG. 5 is a flowchart showing an example of the behavior of a classifying part in the first exemplary embodiment of the present invention;

FIG. 6 is a flowchart showing an example of the behavior of a user interface part in the first exemplary embodiment of the present invention;

FIG. 7 is a diagram showing an example of a classification result display screen in the first exemplary embodiment of the present invention;

FIG. 8 is a block diagram of a second exemplary embodiment of the present invention;

FIG. 9 is a diagram showing an example of the configuration of teacher data in the second exemplary embodiment of the present invention;

FIG. 10 is a diagram showing an example of the configuration of a classification result in the second exemplary embodiment of the present invention;

FIG. 11 is a flowchart showing an example of the behavior of a teacher data generating part in the second exemplary embodiment of the present invention;

FIG. 12 is a diagram showing an example of a teacher data generation screen in the second exemplary embodiment of the present invention;

FIG. 13 is a flowchart showing an example of an operation to automatically correct teacher data in the second exemplary embodiment of the present invention;

FIG. 14 is a diagram showing an example of teacher data before automatic correction in the second exemplary embodiment of the present invention;

FIG. 15 is a diagram showing an example of teacher data after automatic correction in the second exemplary embodiment of the present invention;

FIG. 16 is a block diagram of a third exemplary embodiment of the present invention;

FIG. 17 is a flowchart showing an example of the behavior of a user interface part in the third exemplary embodiment of the present invention;

FIG. 18 is a block diagram of a fourth exemplary embodiment of the present invention;

FIG. 19 is a diagram showing an example of the configuration of a classification result in the fourth exemplary embodiment of the present invention;

FIG. 20 is a flowchart showing an example of the behavior of a classifying part in the fourth exemplary embodiment of the present invention;

FIG. 21 is a flowchart showing an example of the behavior of a user interface part in the fourth exemplary embodiment of the present invention;

FIG. 22 is a block diagram of a fifth exemplary embodiment of the present invention;

FIG. 23 is a flowchart showing an example of the behavior of a user interface part in the fifth exemplary embodiment of the present invention;

FIG. 24 is a block diagram of a sixth exemplary embodiment of the present invention;

FIG. 25 is a flowchart showing an example of a fast-forwarding operation by a user interface part in the sixth exemplary embodiment of the present invention;

FIG. 26 is a flowchart showing an example of a rewinding operation by the user interface part in the sixth exemplary embodiment of the present invention;

FIG. 27 is a block diagram of a seventh exemplary embodiment of the present invention;

FIG. 28 is a flowchart showing an example of the behavior of a user interface part in the seventh exemplary embodiment of the present invention; and

FIG. 29 is a diagram showing an example of a table for determining a maximum display time from confidence in the seventh exemplary embodiment of the present invention.

### EXEMPLARY EMBODIMENT

Next, the exemplary embodiments of the present invention will be described in detail referring to the accompanying drawings.

### First Exemplary Embodiment

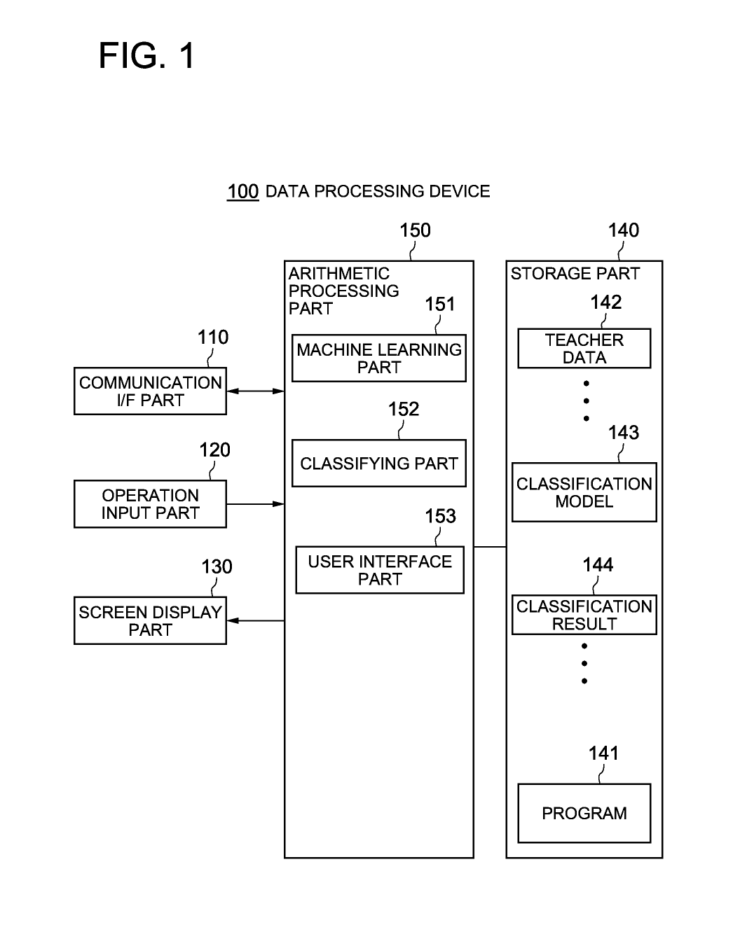

Referring to FIG. 1, a data processing device 100 according to a first exemplary embodiment of the present invention has a function to support a user's operation to check whether or not teacher data used for machine learning is adequate.

This data processing device 100 has, as major functional parts, a communication interface part (hereinafter, referred to as the communication I/F part) 110, an operation input part 120, a screen display part 130, a storage part 140, and an arithmetic processing part 150.

The communication I/F part 110 is composed of a dedicated data communication circuit, and has a function to perform data communication with various kinds of devices connected thereto via communication lines which are not shown in the drawings.

The operation input part 120 is composed of an operation input device such as a keyboard and a mouse, and has a function to detect an operator's operation and output the result to the arithmetic processing part 150.

The screen display part 130 is composed of a screen display device such as a LCD (Liquid Crystal Display) and a PDP (Plasma Display Panel), and has a function to display various kinds of information such as teacher data and a classification result thereof on a screen in response to an instruction from the arithmetic processing part 150.

The storage part 140 is composed of a storage device such as a hard disk and a memory, and has a function to store processing information necessary for various kinds of processing in the arithmetic processing part 150 and a program 141. The program 141 is a program which realizes various kinds of processing parts when loaded in and executed by the arithmetic processing part 150, and is previously loaded from an external device (not shown in the drawings) and a storage medium (not shown in the drawings) via a data input/output function such as the communication I/F part 110 and stored into the storage part 140. Major processing information stored in the storage part 140 is a plurality of teacher data 142, a classification model 143, and a classification result 144.

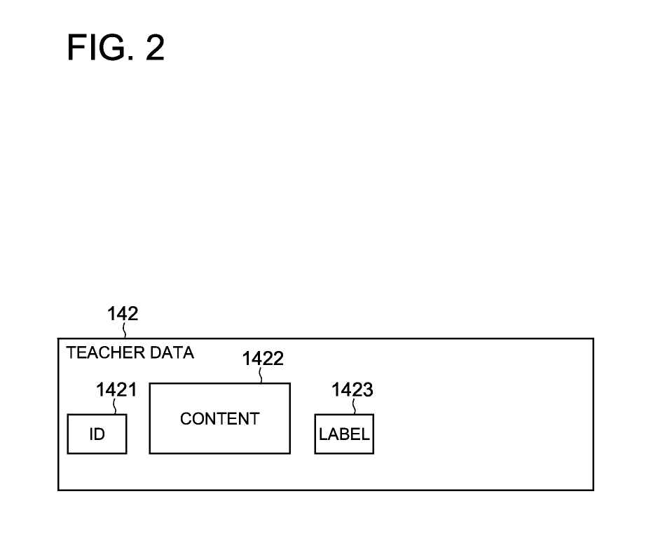

The teacher data 142 is data used for machine learning. FIG. 2 shows an example of the configuration of the teacher data 142. Each of the teacher data 142 is composed of a combination of an ID 1421, content 1422, and a label 1423. The ID 1421 is identification information of the content 1422. The content 1422 may be image data, speech data, text data, or any combination thereof. The label 1423 shows a category to which the content 1422 belongs. The kinds of categories may be two kinds, or may be three or more kinds. For example, in the case of applying the data processing device 100 to video monitoring and detecting an intrusion object from each frame image of video captured by a monitoring camera which is not shown in the drawings, it is possible to assume that the content 1422 is a frame image, the ID 1421 is a frame number or time information for uniquely identifying the frame image, and the label 1423 is either of two kinds including a category representing there is no abnormality (no intrusion object is shown) and a category representing there is an abnormality (an intrusion object is shown).

The teacher data 142 may be previously loaded from an external device (not shown in the drawings) or a storage medium (not shown in the drawings) via a data input/output function such as the communication I/F part 110 and stored into the storage part 140. Otherwise, the teacher data 142 may be generated by the user's input of the label 1423 through the operation input part 120 for the content 1422 having the ID 1421 previously loaded from an external device (not shown in the drawings) or a storage medium (not shown in the drawings) via a data input/output function such as the communication I/F part 110.

The classification model 143 is a classification model generated by using the plurality of teacher data 142. A classification model is a mathematical model of an adequate category for content to belong to. A classification model can be realized by using SVM (Support Vector Machine) or a neural network, for example.

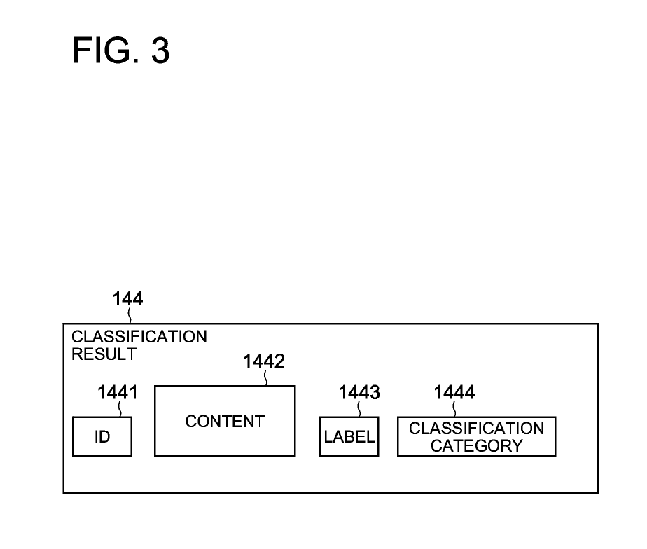

The classification result 144 is information of the result of classification of a category to which the content 1422 of the teacher data 142 belongs by using the classification model 143. FIG. 3 shows an example of the configuration of the classification result 144. Each classification result 144 is composed of a combination of an ID 1441, content 1442, a label 1443, and a classification category 1444. Each classification result 144 corresponds to each teacher data 142 one by one. The ID 1441, the content 1442 and the label 1443 in each classification result 144 are the same as the ID 1421, the content 1422 and the label 1423 in the corresponding teacher data 142. The classification category 1444 in each classification result 144 is a category as a result of determining a category to which the content 1422 in the corresponding teacher data 142 belongs by using the classification model 143. Because the same content 1422 as the content 1442 and the same label 1423 as the label 1443 can be searched for through the teacher data 142 by using the ID 1441 in the classification result 144 as a key, the content 1442 and the label 1443 in the classification result 144 may be omitted.

The arithmetic processing part 150 has a processor like a MPU and a peripheral circuit thereof, and has a function to load the program 141 from the storage part 140 and execute the program to realize various kinds of processing parts by causing the hardware and the program 141 to work in cooperation. Major processing parts realized by the arithmetic processing part 150 are a machine learning part 151, a classifying part 152, and a user interface part 153.

The machine learning part 151 has a function to load the plurality of teacher data 142 from the storage part 140, generate (i.e., learn) the classification model 143 by using the contents 1422 and the labels 1423 in the plurality of teacher data 142, and store the generated classification model 143 into the storage part 140.

The classifying part 152 has a function to load the plurality of teacher data 142 and the classification model 143 from the storage part 140, determine a category to which the content 1422 in each of the plurality of teacher data 142 belongs by using the classification model 143, and store the classification result 144 including the determined category into the storage part 140.

The user interface part 153 has a function to load a plurality of classification results 144 from the storage part 140, and cause the screen display part 130 to display the IDs 1421, the contents 1422, the labels 1443 and the classification categories 1444 in the classification results 144.

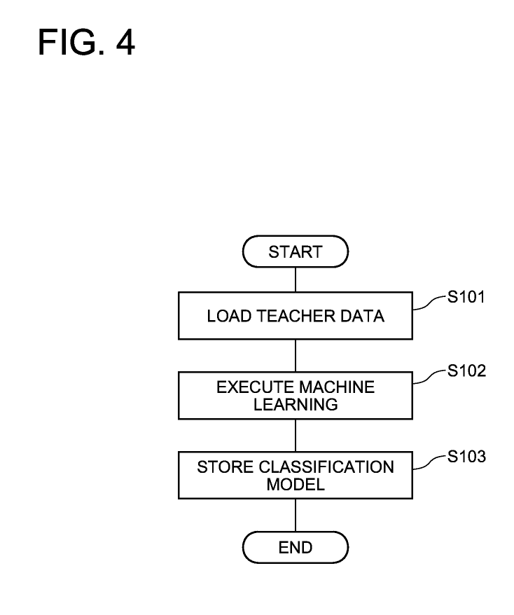

Next, referring to FIGS. 4 to 7, the behavior of the data processing device 100 according to this exemplary embodiment will be described.

First, referring to the flowchart of FIG. 4 showing an example of processing by the machine learning part 151, a machine learning operation by the data processing device 100 according to this exemplary embodiment will be described.

When the machine learning part 151 of the arithmetic processing part 150 of the data processing device 100 is activated, firstly, the machine learning part 151 loads the plurality of teacher data 142 from the storage part 140 (step S101). Next, the machine learning part 151 executes machine learning for generating the classification model 143 by using the contents 1422 and the labels 1423 of the respective teacher data 142 having been loaded (step S102). Finally, the machine learning part 151 stores the classification model 143 generated by machine learning into the storage part 143 (step S103).

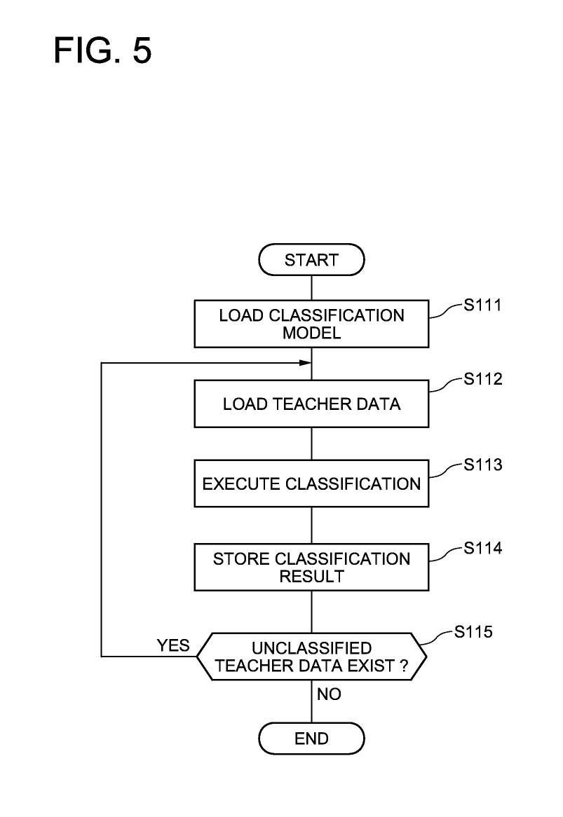

Next, referring to the flowchart of FIG. 5 showing an example of processing by the classifying part 152, a classifying operation by the data processing device 100 according to this exemplary embodiment will be described.

When the classifying part 152 of the arithmetic processing part 150 of the data processing device 100 is activated, firstly, the classifying part 152 loads the classification model 143 from the storage part 140 (step S111). Next, the classifying part 152 loads one of the teacher data 142 having not been classified yet from the storage part 140 (step S112), determines a category to which the content 1442 in the loaded teacher data 142 belongs by using the classification model 143 (step S113), and stores the classification result 144 including the determined category into the storage part 140 (step S114).

Next, the classifying part 152 checks whether or not the teacher data 142 having not been classified yet exists in the storage part 140 (step S115). In a case where the unprocessed teacher data 142 is still left, the classifying part 152 returns to the step S112 and repeats the same process as the abovementioned process. On the other hand, in a case where the unprocessed teacher data 142 is not left, the classifying part 152 ends the classification.

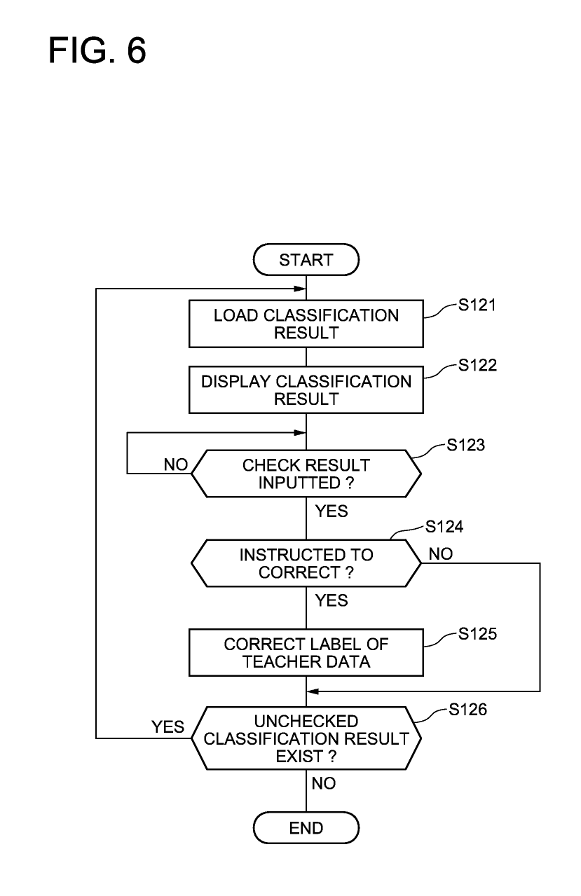

Next, referring to the flowchart of FIG. 6 showing an example of processing by the user interface part 153, a classification result display operation by the data processing device 100 according to this exemplary embodiment will be described.

When the user interface part 153 of the data processing device 100 is activated, firstly, the user interface part 153 loads one of the classification results 144 having not been displayed yet from the storage part 140 (step S121), and causes the screen display part 130 to display the ID 1441, the content 1442, the label 1443 and the classification category 1444 of the loaded classification result 144 (step S122). Then, the user interface part 153 waits for input of a check result from the operation input part 120 (step S123).

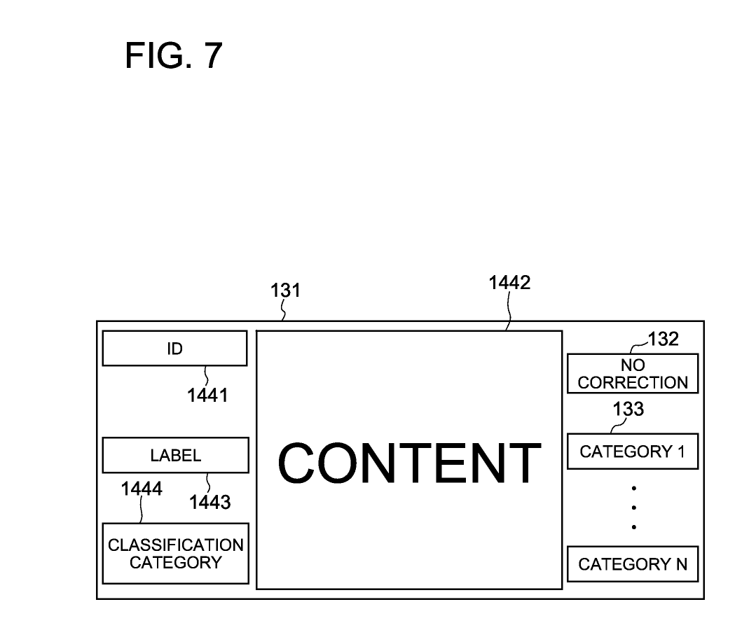

FIG. 7 shows an example of a classification result display screen 131 of the screen display part 130. The classification result display screen 131 of this example displays the content 1442 in the middle of the screen, and displays the ID 1441, the label 1443 and the classification category 1444 on the left side. Moreover, the classification result display screen 131 displays, on the right side, an input button 132 for inputting no correction and an input button 133 for inputting a category for correction.

The user checks the content 1442 displayed on the screen display part 130, and checks whether or not there is no problem in a current state that the category of the content 1442 is the same as the category represented by the label 1443 displayed by the screen display part 130. In a case where there is no problem, the user operates the input button 132 of the operation inputting part 120 to input there is no correction. On the other hand, in the case of determining that the category of the content 1442 is not the category represented by the label 1443 displayed by the display screen part 130, the user operates the operation input part 120 to input the correct category 133. The screen display part 130 displays the classification category 1444 as a result of mechanical classification of the content 1442. Therefore, by using the displayed classification category 1444 as one criterion for determination, the user can determine whether or not there is no problem in that the category of the displayed content 1442 is the category represented by the label 1443, and can determine a correct category for the content 1442 to belong to.

When a check result is inputted from the operation input part 120 (Yes at step S123), the user interface part 153 determines whether the input is an input of absence of correction or an input of presence of correction (step S124). Then, in a case where the input is an input of presence of correction, that is, in a case where a different category from the category represented by the label 1443 displayed by the screen display part 130 is inputted by the user through the input button 133 (Yes at step S124), the user interface part 153 searches for the teacher data 142 having the same ID as the ID 1441 displayed by the screen display part 130 as the ID 1421 from the storage part 140, and updates the value of the label 1443 in the teacher data 142 having been searched for to the category inputted by the user (step S125). Then, the user interface part 153 proceeds to step S126. On the other hand, in a case where the user does not instructs to correct the label (No at step S124), the user interface part 153 skips step S125 and proceeds to step S126.

The user interface part 153 checks whether or not the classification result 144 having not been checked by the user yet exists in the storage part 140. Then, in a case where the unchecked classification result 144 is still left, the user interface part 153 returns to the step S121 and repeats the same process as the abovementioned process. On the other hand, in a case where the unchecked classification result 144 is not left, the user interface part 153 ends the classification result display process.

Thus, according to this exemplary embodiment, it is possible to reduce the user's burden of rechecking whether or not teacher data is adequate. The reason is as the follows.

In a case where incorrect teacher data exists as a very small part in a plurality of teacher data 142 used for generation of the classification model 143, the classification model 143 generated by using the plurality of teacher data 142 tends to classify the content 1422 of the incorrect teacher data 142 into a different category from a category represented by the label 1443 of the incorrect teacher data 142. Therefore, by particularly focusing on the content 1442 of teacher data having the different label 1443 from the classification category 1444 classified by the classifying part 152 displayed by the screen display part 130 and manually determining the adequacy, it is possible to find inadequate teacher data 142 with high efficiency.

Further, according to this exemplary embodiment, the user can correct the label 1443 of the teacher data 142 determined inadequate at the time of check. This is because the user interface part 153 accepts correction on the label of displayed teacher data from the operation input part 120, and corrects the label 1423 of the teacher data 142 in the storage part 140 in accordance with the accepted correction.

### Second Exemplary Embodiment

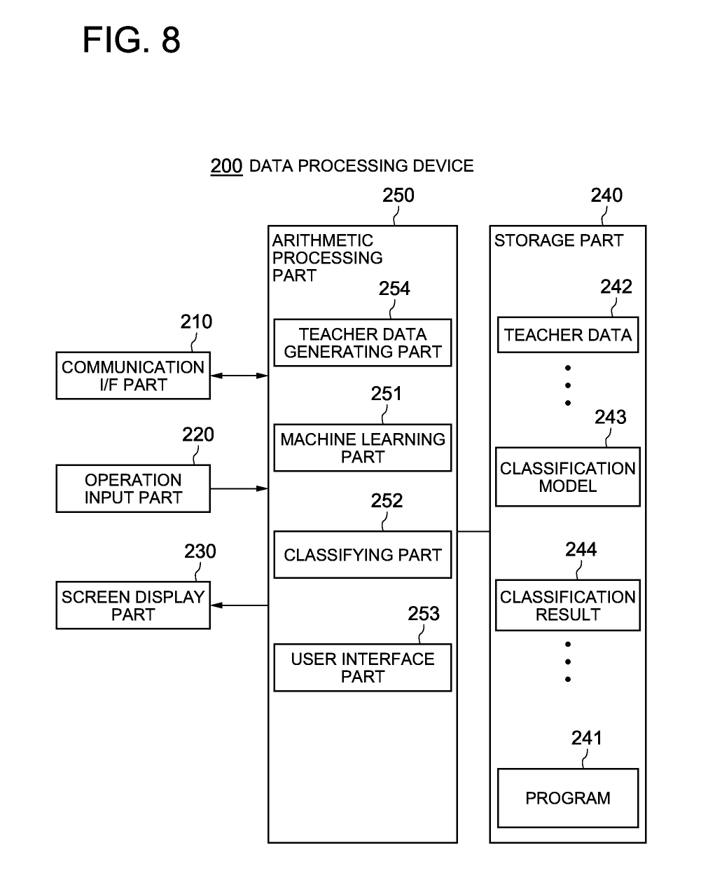

Referring to FIG. 8, a data processing device 200 according to a second exemplary embodiment of the present invention has a function to support a user's operation to generate teacher data used for machine learning, in addition to the functions of the data processing device 100 according to the first exemplary embodiment of the present invention.

This data processing device 200 has, as major functional parts, a communication I/F part 210, an operation input part 220, a screen display part 230, a storage part 240, and an arithmetic processing part 250. Among these parts, the communication I/F part 210, the operation input part 220 and the screen display part 230 have the same functions as the communication I/F part 110, the operation input part 120 and the screen display part 130 of the data processing device 100 according to the first exemplary embodiment of the present invention.

The storage part 240 is composed of a storage device such as a hard disk and a memory, and has a function to store processing information necessary for various kinds of processing in the arithmetic processing part 250 and a program 241. The program 241 is a program which realizes various kinds of processing parts when loaded in and executed by the arithmetic processing part 250, and is previously loaded from an external device (not shown in the drawings) or a storage medium (not shown in the drawings) via a data input/output function such as the communication I/F part 210 and stored into the storage part 240. Major processing information stored in the storage part 240 is a plurality of teacher data 242, a classification model 243, and a classification result 244.

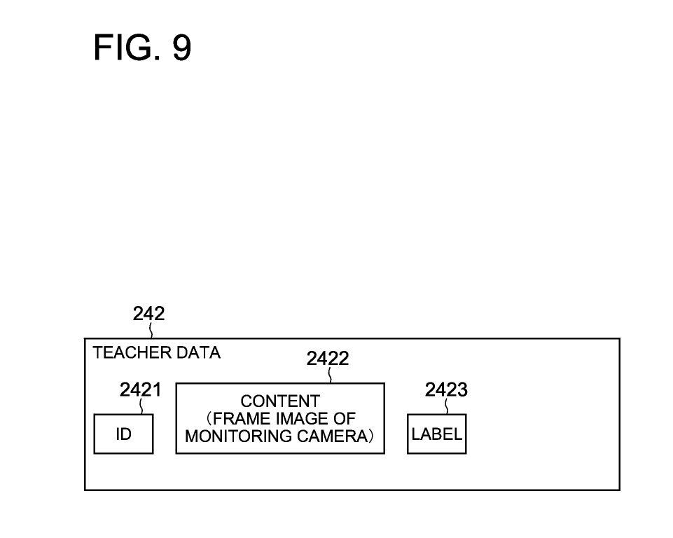

The teacher data 242 are data used for machine learning. FIG. 9 shows an example of the configuration of the teacher data 242. Each teacher data 242 is composed of a combination of an ID 2421, content 2422, and a label 2423. The content 2422 is a frame image of a monitoring camera. The ID 2421 is an identifier of the frame image forming the content 2422. In this exemplary embodiment, the ID 2421 uses time information of the frame. The label 2423 represents the validity of the teacher data 242 and a category to which the content 2422 belongs. In this exemplary embodiment, the label 2423 takes one of three values of −1, 0 and +1. The value −1 represents that the teacher data 242 is valid and the category is a category representing there is no abnormality (no intrusion object is shown). The value +1 represents that the teacher data 242 is valid and the category is a category representing there is an abnormality (an intrusion object is shown). The value 0 represents that the teacher data 242 is invalid.

The classification model 243 is a classification model generated by using, of the plurality of teacher data 242, teacher data in which the labels 2423 are −1 or +1, that is, valid teacher data.

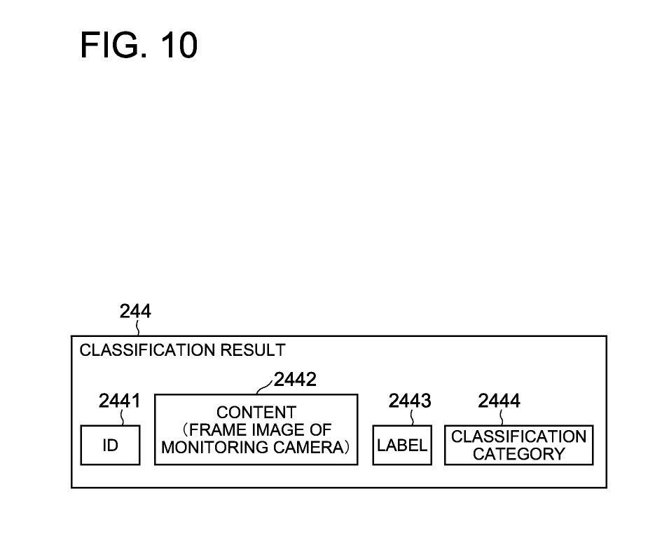

The classification result 244 is information of the result of classification of a category to which the content 2422 of the teacher data 242 belongs by using the classification model 243. FIG. 10 shows an example of the configuration of the classification result 244. Each classification result 244 is composed of a combination of an ID 2441, content 2442, a label 2443, and a classification category 2444. Each classification result 244 corresponds to each of the valid teacher data 242 one by one. The ID 2441, the content 2442 and the label 2443 in each classification result 244 are the same as the ID 2421, the content 2422 and the label 2423 in the corresponding teacher data 242. The classification category 2444 in each classification result 244 is a category as a result of determining a category to which the content 2422 in the corresponding teacher data 242 belongs by using the classification model 243. Because the same content 2422 as the content 2442 and the same label 2423 as the label 2443 can be searched for through the teacher data 242 by using the ID 2441 in the classification result 244 as a key, the content 2442 and the label 2443 in the classification result 244 may be omitted.

The arithmetic processing part 250 has a processor like a MPU and a peripheral circuit thereof, and has a function to load the program 241 from the storage part 240 and execute the program 241 to make the hardware and the program 241 work in cooperation and realize various kinds of processing parts. Major processing parts realized by the arithmetic processing part 250 are a machine learning part 251, a classifying part 252, a user interface part 253, and a teacher data generating part 254.

The teacher data generating part 254 has a function to generate a plurality of teacher data 242. To be specific, the teacher data generating part 254 has: a function to input frame images of a video image of a monitoring camera through the communication I/F part 210 from a video server (not shown in the drawings) which stores video data of the monitoring camera, and cause the screen display part 230 to display the frame images in frame order; a function to accept an input of a category to which each of the frame images displayed by the screen display part 230 through the operation input part 220; and a function to generate the teacher data 242 having the content 2422 that is the frame image, the ID 2421 thereof, and the label 2423 showing the category of the accepted input, and store the teacher data 242 into the storage part 240. Moreover, the teacher data generating part 254 has a function to, in generation of the teacher data 242, from among the plurality of teacher data 242 stored in the storage part 240, detect a pair of teacher data which have frame images temporally adjacent to each other and one of which includes a label with the value −1 and the other of which includes a label with the value +1, and invalidate this pair of teacher data.

The machine learning part 251 has a function to load a plurality of teacher data 242 each of which includes the label 2423 of nonzero (i.e., valid) from the storage part 240, generate (i.e., learn) the classification model 243 by using the content 2422 and the labels 2423 in the plurality of teacher data 242, and store the generated classification model 243 into the storage part 240.

The classifying part 252 has a function to load a plurality of teacher data 242 each of which includes the label 2423 of nonzero (i.e., valid) and the classification model 243 from the storage part 240, determine a category to which the content 2422 in each of the plurality of teacher data 242 belongs, and store the classification result 244 including the determined category into the storage part 240.

The user interface part 253 has a function to load a plurality of classification results 244 from the storage part 240, and cause the screen display part 230 to display the IDs 2421, the contents 2422, the labels 2443 and the classification categories 2444 in the classification results 244.

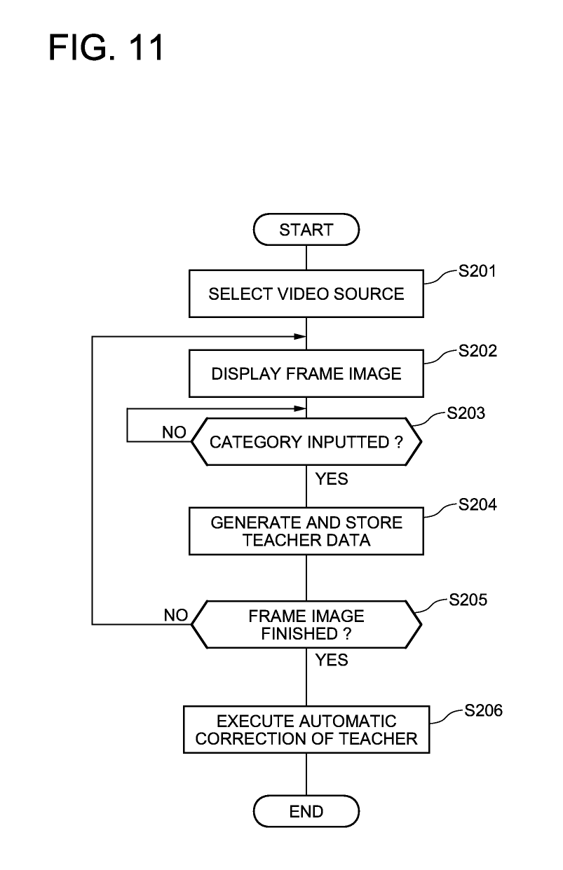

Next, referring to FIGS. 11 to 15, the behavior of the data processing device 200 according to this exemplary embodiment will be described.

First, referring to the flowchart of FIG. 11 showing an example of processing by the teacher data generating part 254, a teacher data generation operation by the data processing device 200 according to this exemplary embodiment will be described.

When the teacher data generating part 254 of the arithmetic processing part 250 of the data processing device 200 is activated, firstly, the teacher data generating part 254 communicates with a video server (not shown in the drawings) through the communication I/F part 210, and selects a video source used for generation of teacher data (step S201). Next, the teacher data generating part 254 acquires a first frame image of the selected video source from the video server through the communication I/F part 210, and causes the screen display part 230 to display the frame image (step S202). Then, the teacher data generating part 254 waits until a category to which the frame image belongs is inputted from the operation input part 220 (step S203).

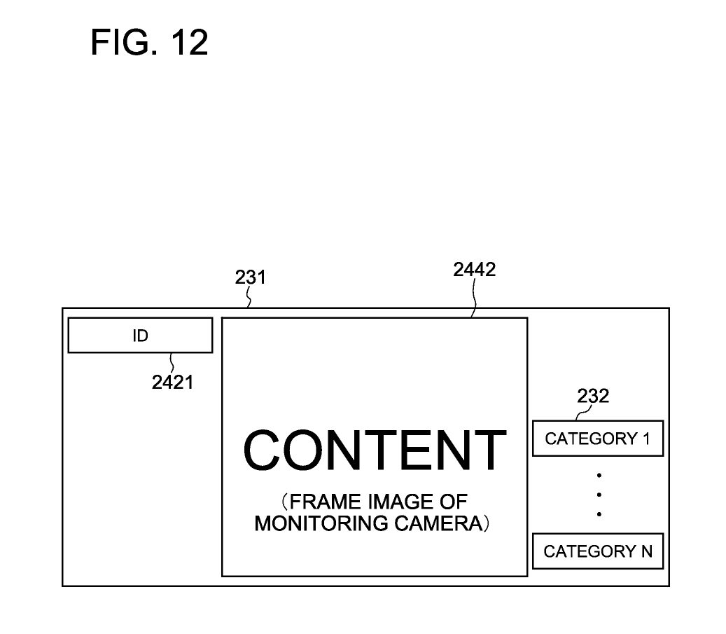

FIG. 12 shows an example of a teacher data generation screen 231 of the screen display part 230. The teacher data generation screen 231 of this example displays the content 2422 that is a frame image in the middle of the screen, and displays the ID 2421 on the left side. Moreover, the teacher data generation screen 231 displays input buttons 232 for the respective categories on the right side.

The user checks the content 2422 displayed by the screen display part 230, determines the category of the content 2422, and operates any one of the input buttons 232. To be specific, in a case where the frame image of the displayed content 2422 is an image with no abnormality (no intruder), the user operates the input button 232 corresponding to the category of absence of abnormality. In a case where the frame image of the displayed content 2422 is an image with an abnormality (an intruder), the user operates the input button 232 corresponding to the category of presence of abnormality.

When a category is inputted from the operation input part 220 (Yes at step S203), the teacher data generating part 254 generates the teacher data 242 composed of the ID 2421 and content 2422 displayed by the screen display part 230 and the label 2423 corresponding to the inputted category, and stores the teacher data into the storage part 240 (step S204). Next, the teacher data generating part 254 checks whether or not a next frame image having not been displayed for the user yet exists (step S205). Then, in a case where an undisplayed frame image is still left, the teacher data generating part 254 returns to the step S202, and repeats the same process as the abovementioned process. On the other hand, in a case where an undisplayed frame image is not left, the teacher data generating part 254 performs automatic correction of teacher data (step S206).

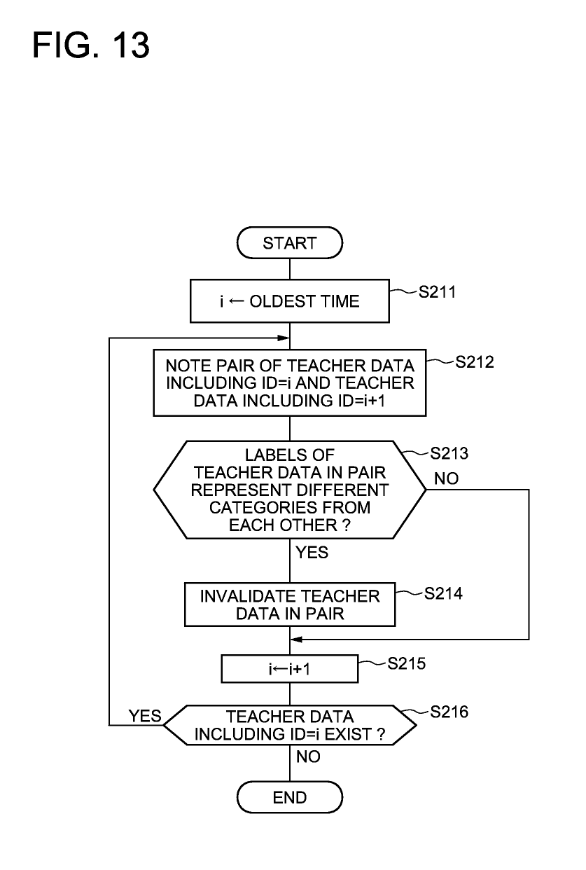

FIG. 13 is a flowchart showing the details of step S206. Firstly, the teacher data generating part 254 sets the ID 2421 indicating the oldest time in the past of the IDs 2421 of the plurality of teacher data 242 to a local variable i (step S211), and notes a pair of the teacher data 242 having ID=i and the teacher data 242 with the content 2422 as a frame image which is next to the frame image having ID=i (step S212). Next, the teacher data generating part 254 determines whether or not the label 2423 of one of the teacher data 242 in the pair is −1 and the label 2423 of the other is +1, that is, whether or not the pair is a pair of teacher data belonging to different categories from each other (step S213). In a case where the pair is a pair of teacher data belonging to different categories from each other, the teacher data generating part 254 updates the labels 2423 of the teacher data 242 in the pair to 0, thereby invalidating both the teacher data 242 in the pair (step S214). Then, the teacher data generating part 254 proceeds to step S215. On the other hand, in a case where it is not a state that the label of one of the teacher data 242 in the pair is −1 and the label of the other is +1, the teacher data generating part 254 skips step S214 and proceeds to step S215.

The teacher data 254 updates the ID indicated by the local variable i to the ID of the next frame image at step S215. Then, the teacher data generating part 254 checks whether or not there is the teacher data 242 with the content 2422 as a frame image which is next to the frame image having the updated ID=i (step S216). In a case where there is such teacher data 242, the teacher data generating part 254 returns to the step S212 and repeats the same process as the abovementioned process. On the other hand, in a case where there is not such teacher data 242, the teacher data generating part 254 ends the automatic correction.

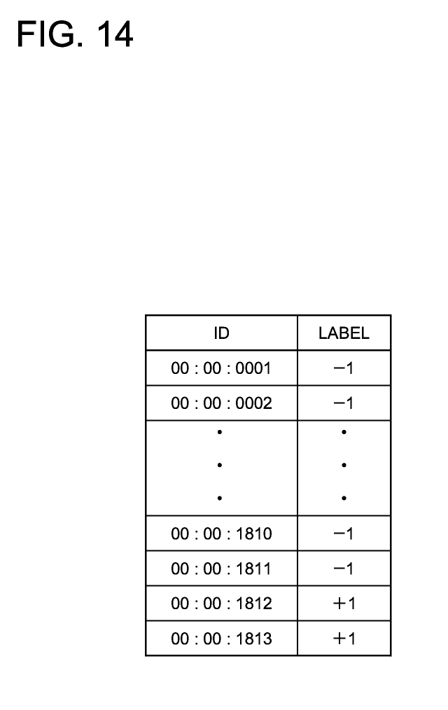

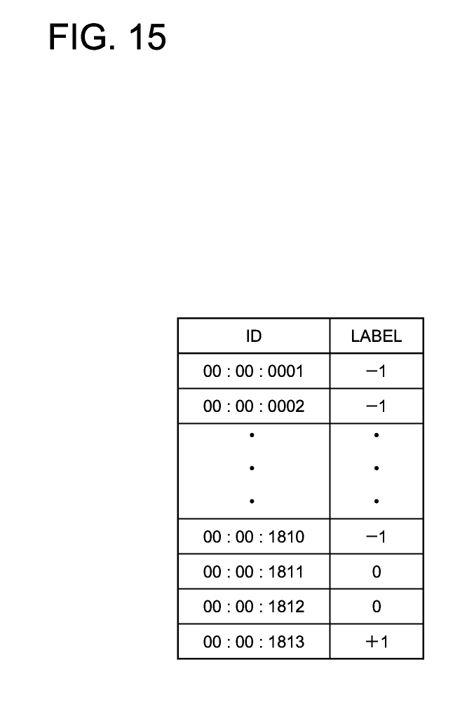

FIG. 14 shows an example of the teacher data 242 before automatic correction, and FIG. 15 shows an example of the teacher data 242 after automatic correction. In FIGS. 14 and 15, the content in the teacher data 242 is not illustrated. Referring to FIG. 14, the label of teacher data having ID=00:00:1811 is −1, and the label of teacher data having ID=00:00:1812 immediately after the abovementioned one is +1. This represents the user's determination that no abnormality (no intruder) exists in a frame image with ID=00:00:1811 and an abnormality (an intruder) exists in a frame image with ID=00:00:1812 immediately after the abovementioned one. In the automatic correction of teacher data at step S206, the teacher data generating part 254 detects a pair of teacher data belonging to different categories from each other as described above and, as shown in FIG. 15, changes the labels thereof to 0, thereby invalidating the teacher data.

Next, a machine learning operation by the data processing device 200 according to this exemplary embodiment will be described by again using the flowchart of FIG. 4 showing the example of processing by the machine learning part 151 in the first exemplary embodiment.

When the machine learning part 251 of the arithmetic processing part 250 of the data processing device 200 is activated, firstly, the machine learning part 251 loads the plurality of teacher data 242 from the storage part 240 (step S101). In this exemplary embodiment, the machine learning part 251 loads the teacher data 242 having the label 2423 of −1 or +1, and does not load the teacher data 242 having the label 2423 of 0. After that, the machine learning part 251 executes the same process as the machine learning part 151 in the first exemplary embodiment (steps S102 and S103).

Next, a classification operation by the data processing device 200 according to this exemplary embodiment will be described by again using the flowchart of FIG. 5 showing the example of the processing by the classifying part 152 in the first exemplary embodiment.

When the classifying part 252 of the arithmetic processing part 250 of the data processing device 200 is activated, firstly, the classifying part 252 loads the classification model 243 from the storage part 240 (step S111). Next, the classifying part 252 loads one of the teacher data 242 having not been classified yet from the storage part 240 (step S112). In this exemplary embodiment, however, the classifying part 252 loads the teacher data 242 having the label 2423 of −1 or +1, and does not load the teacher data having the label 2423 of 0. After that, the classifying part 252 executes the same process as the classifying part 152 in the first exemplary embodiment (steps S113 to S115).

A classification result display operation by the user interface part 253 of the data processing device 200 in this exemplary embodiment is the same as the classification result display operation by the user interface part 153 of the data processing device 100 in the first exemplary embodiment.

Thus, according to this exemplary embodiment, it is possible to acquire the same effects as in the first exemplary embodiment, and moreover, it is possible to acquire the following effect.

In the case of displaying frame images of a video image (a moving image) captured by a monitoring camera in order of time for the user and allowing the user to check each of the displayed frame images and input the presence or absence of an abnormality (the presence or absence of an intruder) as a category, the user's determination tends to be vague in a situation where the presence or absence of an abnormality changes to the opposite. This is because it is not very usual that frame images distinctly switch from a situation where an intruder does not exist to a situation where an intruder exists, and vice versa, and frame images usually switch after one or more frame images in which it is difficult to determine whether or not an intruder exists. As a result, teacher data is likely to be inadequate in a case where the user inputs a category for the abovementioned frame image that makes the user's determination vague. Thus, in this exemplary embodiment, automatic detection and invalidation of teacher data in such a switching situation makes it possible to generate more adequate teacher data. Then, by excluding teacher data with difficulty of determination as described above from teacher data before recheck by the user, it is possible to reduce the number of teacher data that the user needs to recheck, and further reduce the user's burden of rechecking whether or not teacher data is adequate.

In this exemplary embodiment, teacher data of one frame before and one frame after change of the value of the label from −1 to +1 or +1 to −1 are invalidated. However, two frames, three frames, . . . , or m frames before and after the change may be invalidated. Moreover, assuming frame times of teacher data in a pair where the value of the label changes are t and t+a and a preset threshold is T, teacher data having frame time belonging to a period from t+a−T to t+a and teacher data having frame time belonging to a period from t to t+T may be invalidated.

### Third Exemplary Embodiment

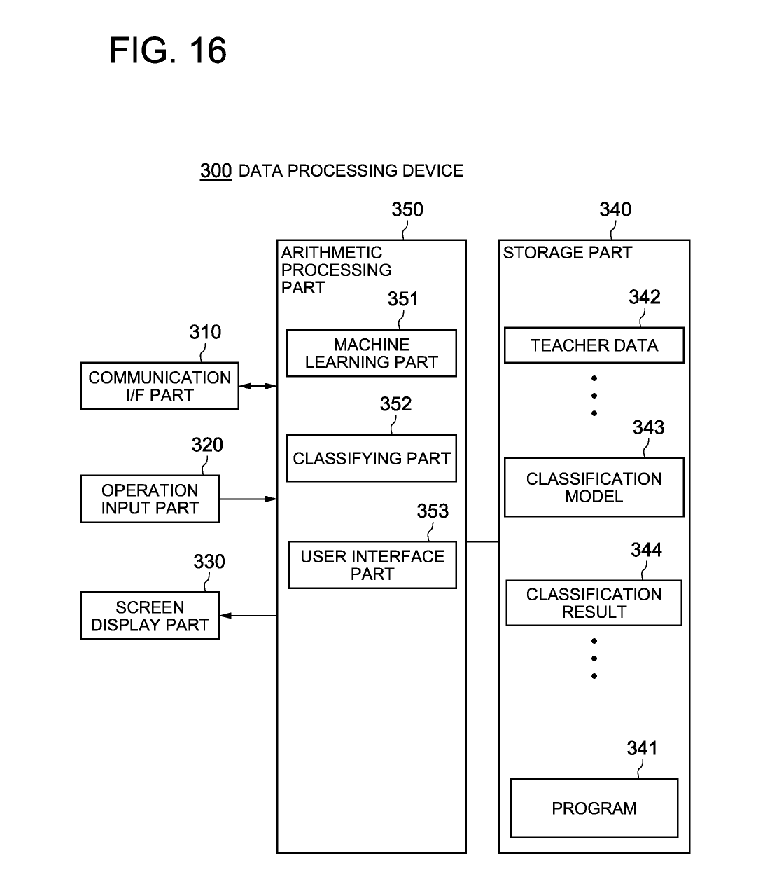

Referring to FIG. 16, a data processing device 300 according to a third exemplary embodiment of the present invention is different from the data processing device 100 according to the first exemplary embodiment of the present invention in that the data processing device 300 makes the user recheck only teacher data whose label represents a different category from a category determined by a classifying part among a plurality of teacher data.

This data processing device 300 has, as major functional parts, a communication I/F part 310, an operation input part 320, a screen display part 330, a storage part 340, and an arithmetic processing part 350. Among these parts, the communication I/F part 310, the operation input part 320 and the screen display part 330 have the same functions as the communication I/F part 110, the operation input part 120 and the screen display part 130 of the data processing device 100 according to the first exemplary embodiment of the present invention.

The storage part 340 is composed of a storage device such as a hard disk and a memory, and has a function to store processing information necessary for various kinds of processing in the arithmetic processing part 350 and a program 341. The program 341 is a program which realizes various kinds of processing parts when loaded in and executed by the arithmetic processing part 350. The program 341 is previously loaded from an external device (not shown in the drawings) or a storage medium (not shown in the drawings) via a data input/output function such as the communication I/F part 310 and stored into the storage part 340. Major processing information stored in the storage part 340 is a plurality of teacher data 342, a classification model 343, and a classification result 344. The plurality of teacher data 342, the classification model 343 and the classification result 344 are the same as the plurality of teacher data 142, the classification model 143 and the classification result 144 of the data processing device 100 according to the first exemplary embodiment of the present invention.

The arithmetic processing part 350 has a processor like a MPU and a peripheral circuit thereof, and has a function to load the program 341 from the storage part 340 and execute the program to make the hardware and the program 341 work in cooperation and realize various kinds of processing parts. Major processing parts realized by the arithmetic processing part 350 are a machine learning part 351, a classifying part 352, and a user interface part 353. Among these parts, the machine learning part 351 and the classifying part 352 have the same function as the machine learning part 151 and the classifying part 152 of the data processing device 100 according to the first exemplary embodiment of the present invention.

The user interface part 353 has a function to load a plurality of classification results 344 from the storage part 340 and cause the screen display part 230 to display IDs (1421), contents (1422), labels (1443) and classification categories (1444) included in the classification results 344. However, the user interface part 353 makes the user recheck only teacher data whose label (1443) represents a different category from a classification category (1444) determined by the classifying part 352 among the plurality of teacher data 342 stored in the storage part 340.

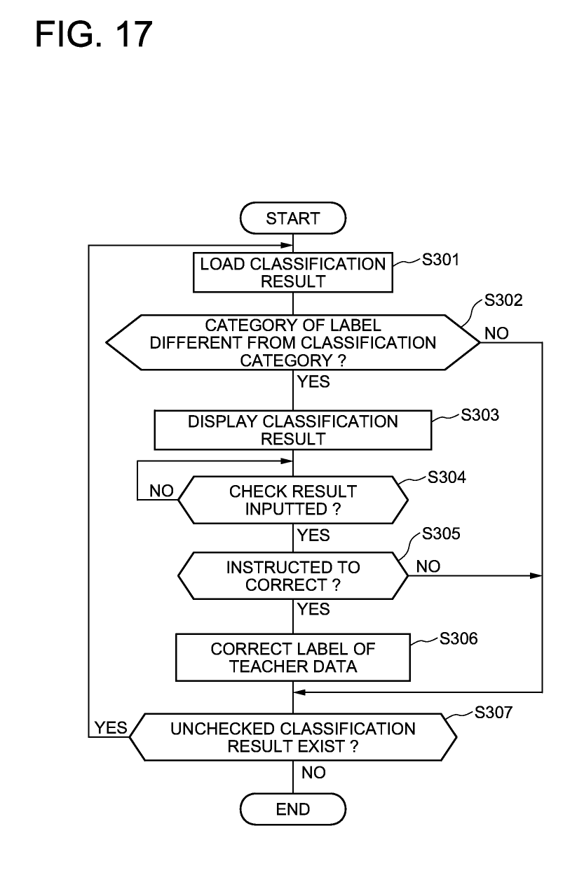

Next, the behavior of the data processing device 300 according to this exemplary embodiment will be described. A machine learning operation and a classification operation by the data processing device 300 according to this exemplary embodiment are the same as the machine learning operation and the classification operation by the data processing device 100 according to the first exemplary embodiment. A classification result display operation by the user interface part 353 of the data processing device 300 in this exemplary embodiment will be described below referring to the flowchart of FIG. 17.

When the user interface part 353 of the data processing device 300 is activated, firstly, the user interface part 353 loads one of the classification results 344 having not been displayed yet from the storage part 340 (step S301). Next, the user interface part 353 determines whether or not a category represented by the label (1443) and the classification category (1444) in the classification result 344 are different from each other (step S302). In a case where the categories are different from each other, the user interface part 353 executes the same process as the process at steps S122 to S125 in the first exemplary embodiment, that is, the user interface part 353 displays the classification result (step S303), waits for input of a check result from the user (step S304), determines the presence or absence of input of correction (step S305) and corrects the label of the teacher data (step S306), and thereafter, proceeds to step S307. On the other hand, in a case where the categories coincide with each other, the user interface part 353 skips steps S303 to S306, and proceeds to step S307.

The user interface part 353 checks at step S307 whether or not the classification result 344 having not been checked by the user yet exists in the storage part 340. Then, in a case where the unchecked classification result 344 is still left, the user interface part 353 returns to step S301 and repeats the same process as the abovementioned process. On the other hand, in a case where the unchecked classification result 344 is not left, the user interface part 353 ends the classification result display process.

Thus, according to this exemplary embodiment, it is possible to reduce the user's burden of rechecking whether or not teacher data is adequate or not. The reason is as follows.

In a case where the plurality of teacher data 342 used for generation of the classification model 343 contains incorrect teacher data a little, the classification model 343 generated by using the plurality of teacher data 342 tends to classify the content (1422) of the incorrect teacher data 342 into a different category from a category represented by the label (1443) of the teacher data 342. Therefore, by causing the user to determine whether or not a label is adequate for content with respect to only the teacher data having the label (1443) different from the classification category (1444) determined by the classifying part 152, it is possible to efficiently find the inadequate teacher data 342.

### Fourth Exemplary Embodiment

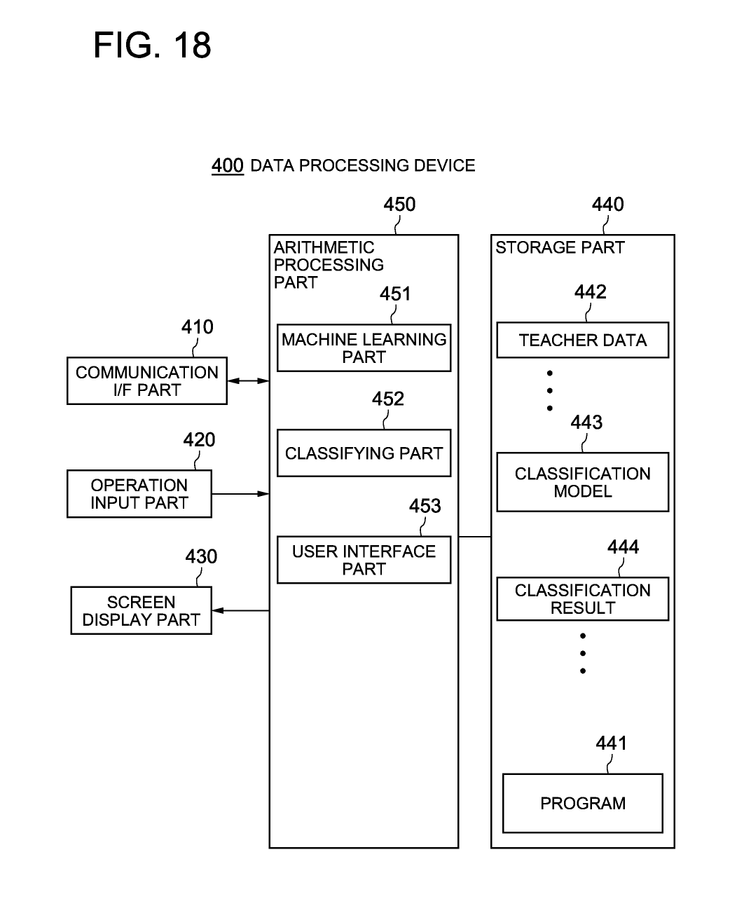

Referring to FIG. 18, a data processing device 400 according to a fourth exemplary embodiment of the present invention is different from the data processing device 100 according to the first exemplary embodiment of the present invention in that the data processing device 400 makes the user recheck only teacher data in which confidence of a category determined by a classifying part is equal to or less than a predetermined threshold among a plurality of teacher data.

This data processing device 400 has, as major functional parts, a communication I/F part 410, an operation input part 420, a screen display part 430, a storage part 440, and an arithmetic processing part 450. Among these parts, the communication I/F part 410, the operation input part 420 and the screen display part 430 have the same functions as the communication I/F part 110, the operation input part 120 and the screen display part 130 of the data processing device 100 according to the first exemplary embodiment of the present invention.

The storage part 440 is composed of a storage device such as a hard disk and a memory, and has a function to store processing information necessary for various kinds of processing in the arithmetic processing part 450 and a program 441. The program 441 is a program which realizes various kinds of processing parts when loaded in and executed by the arithmetic processing part 450. The program 441 is previously loaded from an external device (not shown in the drawings) or a storage medium (not shown in the drawings) via a data input/output function such as the communication I/F part 410 and stored into the storage part 440. Major processing information stored in the storage part 440 is a plurality of teacher data 442, a classification model 443, and a classification result 444. The plurality of teacher data 442 and the classification model 443 are the same as the plurality of teacher data 142 and the classification model 143 of the data processing device 100 according to the first exemplary embodiment of the present invention.

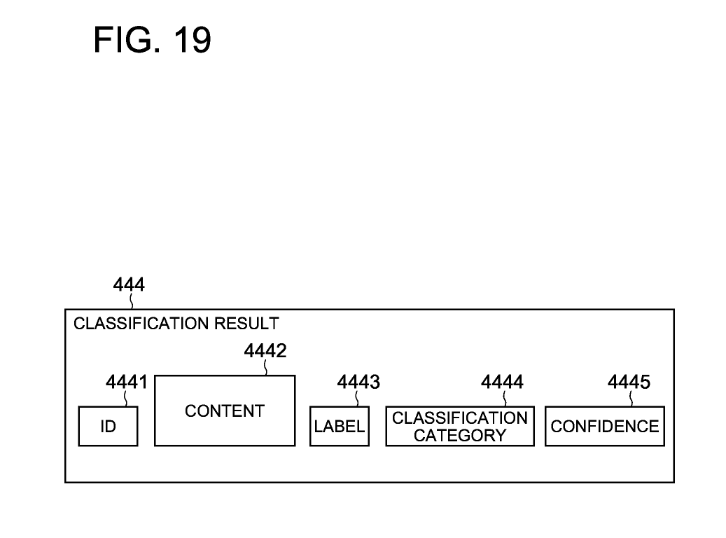

The classification result 444 is information of the result of classification of a category to which the content (1422) of the teacher data 442 belongs by using the classification model 443. FIG. 19 is an example of the configuration of the classification result 444. Each classification result 444 is composed of a combination of an ID 4441, content 4442, a label 4443, a classification category 4444 and confidence 4445. Each classification result 444 corresponds to each teacher data 442 one by one. The ID 4441, the content 4442 and the label 4443 in each classification result 444 are the same as the ID (1421), the content (1422) and the label (1423) in the corresponding teacher data 442. The classification category 4444 in each classification result 444 is a category as a result of determination of a category to which the content (1422) in the corresponding teacher data 442 belongs by using the classification model 443.

The confidence 4445 in each classification result 444 is confidence of the classification category 4444 in the same classification result 444. For example, in a case where the classification model 443 is SVM, the confidence 4445 is equivalent to “probability estimates.” In this exemplary embodiment, it is assumed that the confidence 4445 takes values from 0 to 1, and that the accuracy of the classification category 4444 becomes higher as the value of the confidence 4445 is closer to 1 and the accuracy of the classification category 4444 becomes lower as the value of the confidence 4445 is closer to 0. For example, when the classification category 4444 is −1 representing the absence of abnormality and the confidence is 1, it shows that the content 4442 belongs to a category of the absence of abnormality with a probability of 100%. Moreover, when the classification category 4444 is +1 representing the presence of abnormality and the confidence is 1, it shows that the content 4442 belongs to a category of the presence of abnormality with a probability of 100%. Moreover, when the classification category 4444 is −1 representing the absence of abnormality or +1 representing the presence of abnormality and the confidence is 0, it shows that a probability that the content 4442 belongs to the category of the absence of abnormality and a probability that the content 4442 belongs to the category of the presence of abnormality are both 50%. Herein, the classification category 4444 and the confidence thereof 4445 are separately handled, but may be integrated. For example: when the content 4442 belongs to the category of the absence of abnormality with a probability of 80%, the value of the classification category 4444 may be represented by −0.8; when belongs to the category of the presence of abnormality with a probability of 100%, the value of the classification category 4444 may be represented by +1.0; and when the probabilities are both 50%, the value of the classification category 4444 may be represented by 0. Because the same content (1422) as the content 4442 and the same label (1423) as the label 4443 can be searched for through the teacher data 442, the content 4442 and the label 4443 in the classification result 444 may be omitted.

The arithmetic processing part 450 has a processor like a MPU and a peripheral circuit thereof, and has a function to load the program 441 from the storage part 440 and execute the program to make the hardware and the program 441 work in cooperation and realize various kinds of processing parts. Major processing parts realized by the arithmetic processing part 450 are a machine learning part 451, a classifying part 452, and a user interface part 453. Among these parts, the machine learning part 451 has the same function as the machine learning part 151 of the data processing device 100 according to the first exemplary embodiment of the present invention.

The classifying part 452 has a function to load the plurality of teacher data 442 and the classification model 443 from the storage part 440, determine a category to which the content (1422) in each of the plurality of teacher data 442 belongs and confidence thereof by using the classification model 443, and store the classification result 444 including the determined category and confidence into the storage part 440.

The user interface part 453 has a function to load a plurality of classification results 444 from the storage part 440 and cause the screen display part 430 to display IDs 4421, contents 4422, labels 4443 and classification categories 4444 included in the classification results 444. However, in the abovementioned display, the user interface part 453 makes the user recheck only teacher data in which the confidence 4445 is equal to or less than a threshold α among the plurality of classification results 444. The threshold α is previously determined. The threshold α may be a fixed value, or a variable value which can be changed through the operation input part 420. For example, in a case where the confidence 4445 takes values from 0 to 1 and, as the value of the confidence 4445 is closer to 0, a probability of classification of the content 4422 into a category indicated by the classification category 4444 becomes lower, the threshold α can be set within a range from 0 to 1. In this case, as the threshold α is set to a value closer to 0, the number of teacher data to be rechecked can be further limited, but failure to check inadequate teacher data is easily caused. Therefore, the value of the threshold α is determined by a tradeoff between reduction of the user's burden and the accuracy of teacher data.

Next, the behavior of the data processing device 400 according to this exemplary embodiment will be described. A machine learning operation of the data processing device 400 according to this exemplary embodiment is the same as the machine learning operation of the data processing device 100 according to the first exemplary embodiment. A classification operation by the classifying part 452 of the data processing device 400 in this exemplary embodiment and a classification result display operation by the user interface part 453 will be described below.

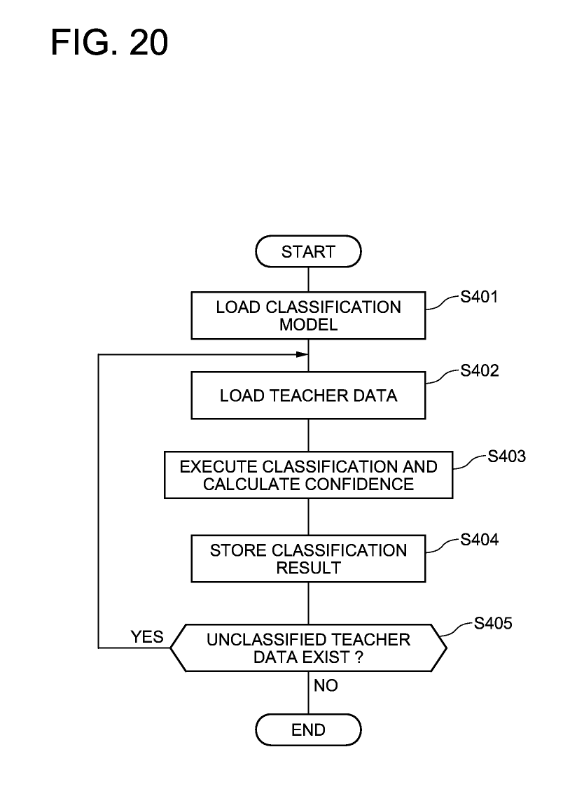

Firstly, referring to the flowchart of FIG. 20 showing an example of processing by the classifying part 452, the classification operation by the data processing device 400 according to this exemplary embodiment will be described.

When the classifying part 452 of the arithmetic part 450 of the data processing device 400 is activated, firstly, the classifying part 452 loads the classification model 443 from the storage part 440 (step S401). Next, the classifying part 452 loads one of the teacher data 442 having not been classified yet from the storage part 440 (step S402), determines a category to which the content (1442) in the teacher data 442 belongs and confidence thereof by using the classification model 443 (step S403), and stores the classification result 444 including the determined category and confidence into the storage part 440 (step S404). Next, the classifying part 452 checks whether or not the teacher data 442 having not been classified yet exists in the storage part 440 (step S405) and, in a case where the unprocessed teacher data 442 is still left, the classifying part 452 returns to the step S401 and repeats the same process as the abovementioned process. On the other hand, in a case where the unprocessed teacher data 442 is not left, the classifying part 452 ends the classification.

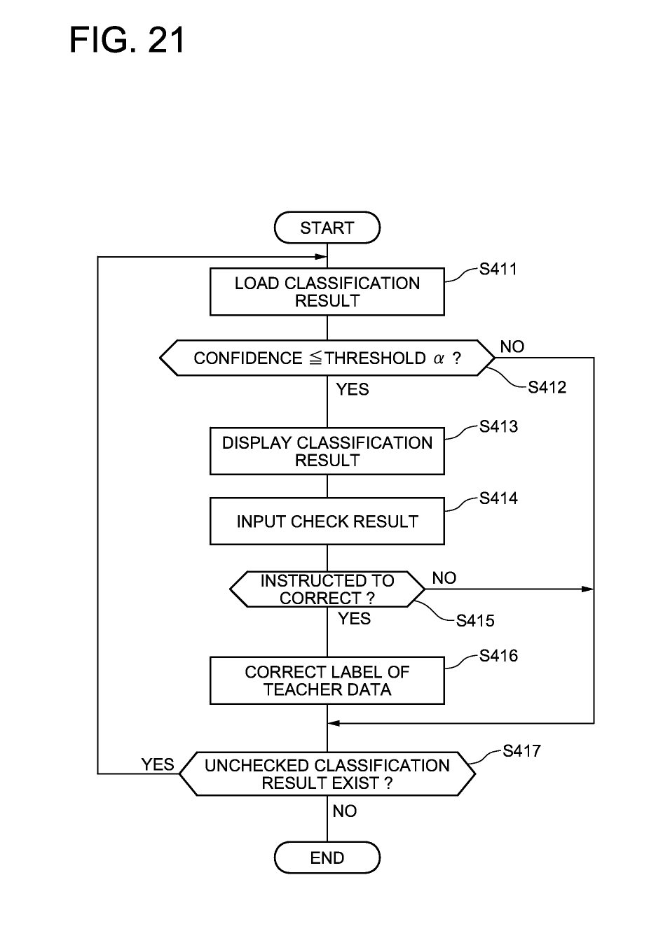

Next, referring to the flowchart of FIG. 21 showing an example of processing by the user interface part 453, the classification result display operation by the data processing device 400 according to this exemplary embodiment will be described.

When the user interface part 453 of the data processing device 400 is activated, firstly, the user interface part 453 loads one of the classification results 444 having not been displayed yet from the storage part 440 (step S411). Next, the user interface part 453 determines whether or not the confidence 4445 in the classification result 444 is equal to or less than the threshold α (step S412). In a case where the confidence 4445 is equal to or less than the threshold α, the user interface part 453 executes the same process as the process at steps S122 to S125 in the first exemplary embodiment, that is, the user interface part 453 displays a classification result (step S413), waits for input of a check result from the user (step S414), determines the presence or absence of input of correction (step S415) and corrects the label of teacher data (step S416), and thereafter, proceeds to step S417. On the other hand, in a case where the confidence 4445 is not equal to or less than the threshold α, the user interface part 453 skips the steps S413 to S416, and proceeds to step S417.

The user interface part 453 checks at step S417 whether or not the classification result 444 having not been checked by the user yet exists in the storage part 440. Then, in a case where the unchecked classification result 444 is still left, the user interface part 453 returns to the step S411 and repeats the same process as the abovementioned process. On the other hand, in a case where the unchecked classification result 444 is not left, the user interface part 453 ends the display of the classification results.

Thus, according to this exemplary embodiment, it is possible to efficiently find inadequate teacher data from among the plurality of teacher data 442. The reason is as follows.

In a case where the plurality of teacher data 442 used for generation of the classification model 443 contains incorrect teacher data a little, the classification model 443 generated by using the plurality of teacher data 442 tends to classify the content (1422) of the incorrect teacher data 442 into a different category from a category represented by the label (1443) of the teacher data 442. The confidence 4445 in this case is likely to be not very high. On the other hand, the classification model 443 tends to classify the content (1422) of the obviously correct teacher data 442 into the same category as a category represented by the label (1443) of the teacher data 442. The confidence in this case is likely to be high. Therefore, by causing the screen display part 430 to display only the classification result 444 that the confidence 4445 is equal to or less than the threshold α among the plurality of classification results 444, it is possible to securely make the user recheck the classification result 444 relating to the teacher data 442 that a category represented by the label (1443) is different from the classification category 4444, and it is also possible to restrict the number of the classification results 444 to recheck. Thus, the user can particularly note the content 4442 of teacher data having the label 4443 that is different from the classification category 4444 displayed by the display part 430, and more efficiently conduct an operation to determine the adequacy.

### Fifth Exemplary Embodiment

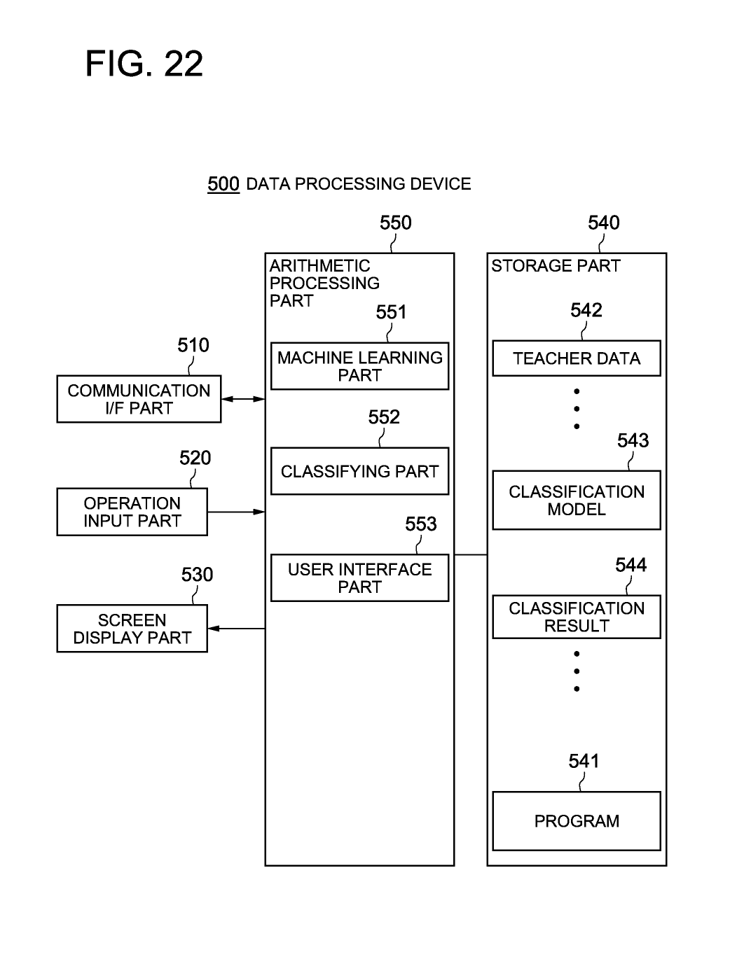

Referring to FIG. 22, a data processing device 500 according to a fifth exemplary embodiment of the present invention is different from the data processing device 400 according to the fourth exemplary embodiment of the present invention in that the data processing device 500 automatically invalidates, of a plurality of teacher data, teacher data in which confidence of a category determined by a classifying part is equal to or less than a predetermined threshold.

This data processing device 500 has, as major functional parts, a communication I/F part 510, an operation input part 520, a screen display part 530, a storage part 540, and an arithmetic processing part 550. Among these parts, the communication I/F part 510, the operation input part 520 and the screen display part 530 have the same functions as the communication I/F part 410, the operation input part 420 and the screen display part 430 of the data processing device 400 according to the fourth exemplary embodiment of the present invention.

The storage part 540 is composed of a storage device such as a hard disk and a memory, and has a function to store processing information necessary for various kinds of processing in the arithmetic processing part 550 and a program 541. The program 541 is a program which realizes various kinds of processing parts when loaded in and executed by the arithmetic processing part 550. The program 541 is previously loaded from an external device (not shown in the drawings) or a storage medium (not shown in the drawings) via a data input/output function such as the communication I/F part 510 and stored into the storage part 540. Major processing information stored in the storage part 540 is a plurality of teacher data 542, a classification model 543, and a classification result 544. The plurality of teacher data 542, the classification model 543 and the classification result 544 are the same as the plurality of teacher data 442, the classification model 443 and the classification result 444 of the data processing device 400 according to the fourth exemplary embodiment of the present invention.

The arithmetic processing part 550 has a processor like a MPU and a peripheral circuit thereof, and has a function to load the program 541 from the storage part 540 and execute the program to make the hardware and the program 541 work in cooperation and realize various kinds of processing parts. Major processing parts realized by the arithmetic processing part 550 are a machine learning part 551, a classifying part 552, and a user interface part 553. Among these parts, the machine learning part 551 and the classifying part 552 have the same functions as the machine learning part 451 and the classifying part 452 of the data processing device 400 according to the fourth exemplary embodiment of the present invention.

The user interface part 553 has a function to load a plurality of classification results 544 from the storage part 540 and cause the screen display part 530 to display an ID (4421), content (4422), a label (4443) and a classification category (4444) included in each of the classification results 544. In the abovementioned display, however, the user interface part 553 does not display the classification result 544 that confidence (4445) is equal to or less than a threshold β, and also invalidates teacher data corresponding thereto. The threshold β is previously determined. The threshold β may be a fixed value, or may be a variable value which can be changed through the operation input part 520. For example, in a case where the confidence (4445) takes values from 0 to 1 and, as the value of the confidence (4445) is closer to 0, a probability of classification of the content (4422) into a category indicated by the classification category (4444) becomes lower, the threshold β can be set in a range from 0 to 1. In this case, as the threshold β is set to a value closer to 1, the number of invalidated teacher data increases and the number of teacher data which the user needs to recheck decreases, but the number of teacher data which can be utilized for relearning of a classification model decreases. On the other hand, as the threshold β is set to a value closer to 0, the number of invalidated teacher data decreases and the number of teacher data which can be utilized for relearning of a classification model increases, but the number of teacher data which the user needs to recheck increases and the user's burden increases. The threshold β is determined in advance in consideration of the above matters.

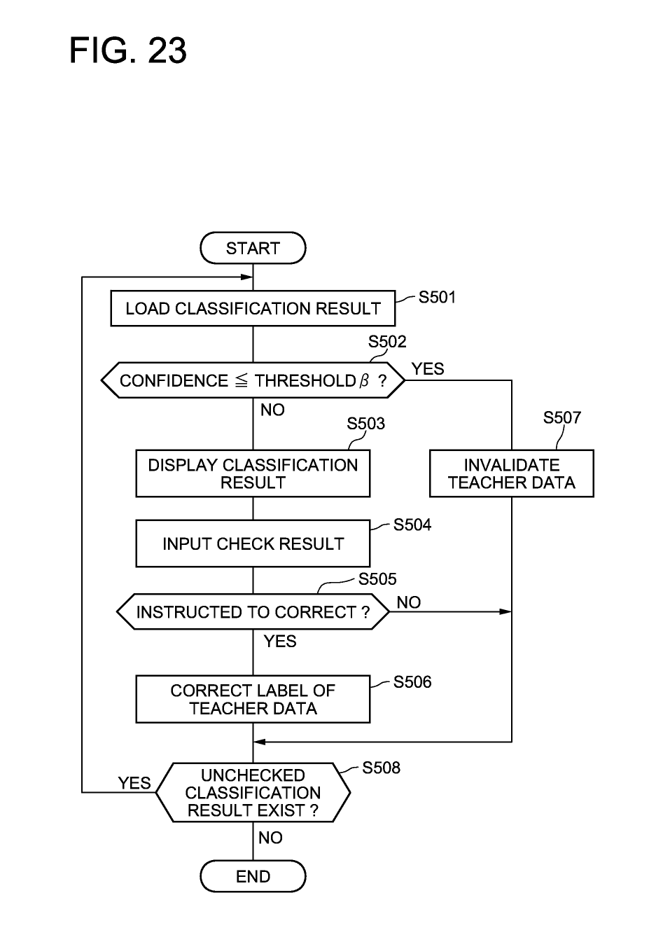

Next, the behavior of the data processing device 500 according to this exemplary embodiment will be described. A machine learning operation a classification operation by the data processing device 500 according to this exemplary embodiment are the same as the machine learning operation and the classification operation by the data processing device 400 according to the fourth exemplary embodiment. A classification result display operation by the user interface part 553 of the data processing device 500 in this exemplary embodiment will be described below referring to the flowchart of FIG. 23 showing an example of processing by the user interface part 553.

When the user interface part 553 of the data processing device 500 is activated, firstly, the user interface part 553 loads one of the classification results 544 having not been displayed yet from the storage part 540 (step S501). Next, the user interface part 553 determines whether or not the confidence (4445) in the classification result 544 is equal to or less than the threshold β (step S502). In a case where the confidence (4445) is not equal to or less than the threshold β, the user interface part 553 executes the same process as the process at the steps S413 to S416 in the fourth exemplary embodiment, that is, the user interface part 553 displays the classification result (step S503), waits for input of a check result by the user (step S504), determines the presence or absence of input of correction (step S505) and corrects the label of teacher data (step S506), and thereafter, proceeds to step S508. On the other hand, in a case where the confidence (4445) is equal to or less than the threshold β, the user interface part 553 invalidates the teacher data 542 corresponding to the classification result 544 (step S507), skips steps S503 to S506, and proceeds to step S508. In the invalidation at step S507, the user interface part 553 searches for the teacher data 542 having the same ID as the ID (4441) in the classification result 544 from the storage part 540, and invalidates the teacher data 542 having been searched for by changing the value of the label of the teacher data having been searched for to a value indicating invalid or by deleting this teacher data 542.

The user interface part 553 checks at step S508 whether or not the classification result 544 having not been checked by the user yet exists in the storage part 540. Then, in a case where the unchecked classification result 544 is still left, the user interface part 553 returns to the step S501 and repeats the same process as the abovementioned process. On the other hand, in a case where the unchecked classification result 544 is not left, the user interface part 553 ends the display of the classification results.

Thus, according to this exemplary embodiment, it is possible to reduce the user's burden of rechecking whether or not teacher data is adequate. The reason is as follows.

In a case where the plurality of teacher data 542 used for generation of the classification model 543 contain a little the teacher data 542 generated by the user's struggle to determine a category, the classification model 543 generated by using the plurality of teacher data 542 classifies the content (1422) of the teacher data 542 generated by the struggle to determine into a category which is the same as or different from a category indicated by the label (1443) of the teacher data 542, and the confidence (4445) in this case tends to be not very high. The user's operation to recheck such teacher data that the confidence is not very high and determine the category thereof causes increase of the user's burden. Moreover, because teacher data that the confidence is equal to or less than the threshold is likely to be wrong as teacher data, it is not appropriate to keep using such teacher data. Therefore, in this exemplary embodiment, by invalidating teacher data with the confidence (4445) equal to or less than the threshold β without making the user recheck, the accuracy of teacher data is enhanced while the user's burden of rechecking the adequacy of teacher data is reduced.

### Sixth Exemplary Embodiment

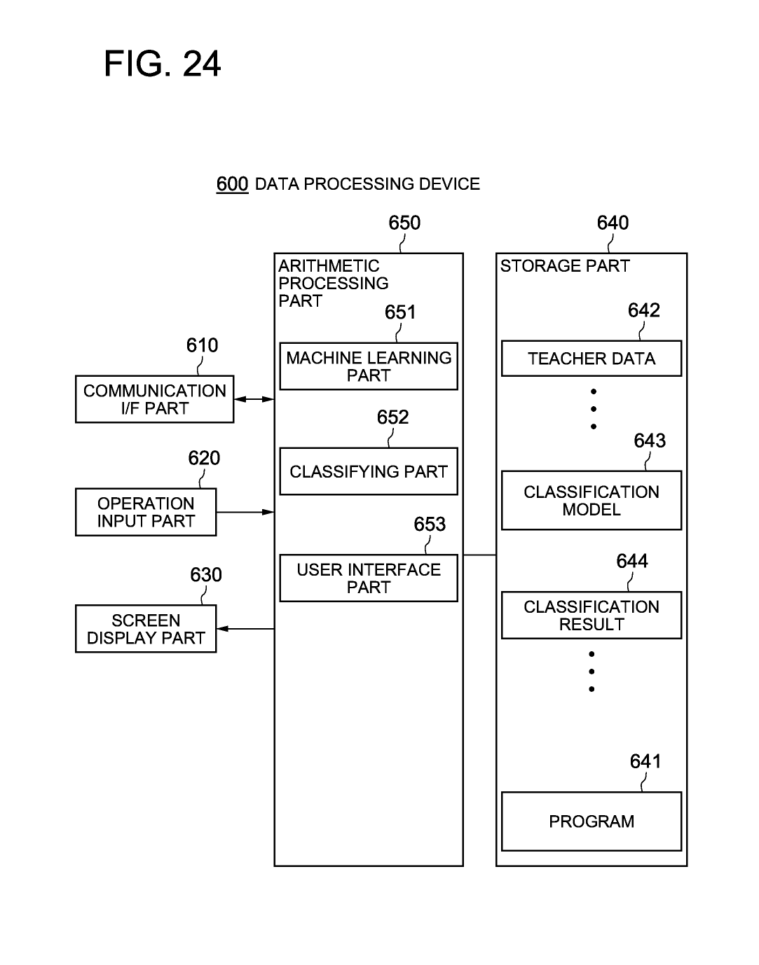

Referring to FIG. 24, a data processing device 600 according to a sixth exemplary embodiment of the present invention is different from the data processing device 400 according to the fourth exemplary embodiment of the present invention in that the data processing device 600 has a function to, when the user rechecks teacher data, fast-forward or rewind teacher data of the rechecking target to other teacher data that confidence of a category is equal to or less than a predetermined threshold.

This data processing device 600 has, as major functional parts, a communication I/F part 610, an operation input part 620, a screen display part 630, a storage part 640, and an arithmetic processing part 650. Among these parts, the communication I/F part 610, the operation input part 620 and the screen display part 630 have the same functions as the communication I/F part 410, the operation input part 420 and the screen display part 430 of the data processing device 400 according to the fourth exemplary embodiment of the present invention.

The storage part 640 is composed of a storage device such as a hard disk and a memory, and has a function to store processing information necessary for various kinds of processing in the arithmetic processing part 650 and a program 641. The program 641 is a program which realizes various kinds of processing parts when loaded in and executed by the arithmetic processing part 650. The program 641 is previously loaded from an external device (not shown in the drawings) or a storage medium (not shown in the drawings) via a data input/output function such as the communication I/F part 610 and stored into the storage part 640. Major processing information stored in the storage part 640 is a plurality of teacher data 642, a classification model 643, and a classification result 644. The plurality of teacher data 642, the classification model 643 and the classification result 644 are the same as the plurality of teacher data 442, the classification model 443 and the classification result 444 of the data processing device 400 according to the fourth exemplary embodiment of the present invention.

The arithmetic processing part 650 has a processor like a MPU and a peripheral circuit thereof, and has a function to load the program 641 from the storage part 640 and execute the program to make the hardware and the program 641 work in cooperation and realize various kinds of processing parts. Major processing parts realized by the arithmetic processing part 650 are a machine learning part 651, a classifying part 652, and a user interface part 653. Among these parts, the machine learning part 651 and the classifying part 652 have the same functions as the machine learning part 451 and the classifying part 452 of the data processing device 400 according to the fourth exemplary embodiment of the present invention.

The user interface part 653 has a function to load a plurality of classification results 644 from the storage part 640 and cause the screen display part 630 to display an ID (4421), content (4422), a label (4443) and a classification category (4444) included in each of the classification results 644.

Further, the user interface part 653 has a fast-forwarding function to, when a fast-forwarding instruction is inputted by the user through the operation input part 620 during the abovementioned display, search for another classification result 644 which is located rearward of a currently displayed classification result 644 and which includes a classification category with the confidence (4445) equal to or less than a preset threshold γ, through the storage part 640, switch the display screen of the screen display part 630, and cause the screen display part 630 to display the ID (4421), the content (4422), the label (4443) and the classification category (4444) included in the classification result 644 having been searched for.

Further, the user interface part 653 has a rewinding function to, when a rewinding instruction is inputted by the user through the operation input part 620 during the abovementioned display, search for another classification result 644 which is located forward of a currently displayed classification result 644 and which includes a classification category with the confidence (4445) equal to or less than a preset threshold γ, through the storage part 640, switch the display screen of the screen display part 630, and cause the screen display part 630 to display the ID (4421), the content (4422), the label (4443) and the classification category (4444) included in the classification result 644 having been searched for.

The threshold γ is previously determined. The threshold γ may be a fixed value, or may be a variable value which can be changed through the operation input part 720. For example, in a case where the confidence (4445) takes values from 0 to 1 and, as the value of the confidence (4445) is closer to 0, a probability of classification of the content (4422) into a category indicated by the classification category (4444) decreases, the threshold γ can be set within a range from 0 to 1. In this case, as the threshold γ is set to a value closer to 0, the number of teacher data that can be fast-forwarded or rewound can be further limited, but failure to check inadequate teacher data is easily caused. Therefore, the value of the threshold γ is determined by a tradeoff between reduction of the user's burden and the accuracy of teacher data.

Herein, rearward of the classification result 644 refers to a classification result having an ID of a larger value than the ID (4421) included in this classification result 644 and, on the contrary, forward of the classification result 644 refers to a classification result having an ID of a smaller value than the ID (4421) included in this classification result 644. For example, when a frame image is used as content and time information of the frame image is used as an ID, rearward refers to temporarily rearward and forward refers to temporarily forward.

Further, when a plurality of classification results which satisfy the conditions exist rearward or forward of a classification result 644 as the origination, a classification result 644 including an ID having the smallest difference from the ID (4421) of the origination classification result 644 is assumed to be a fast-forwarding destination or a rewinding destination.

Next, the behavior of the data processing device 600 according to this exemplary embodiment will be described. A machine learning operation and a classification operation by the data processing device 600 according to this exemplary embodiment are the same as the machine learning operation and the classification operation by the data processing device 400 according to the fourth exemplary embodiment. Moreover, of a classification result display operation by the user interface part 653 of the data processing device 600 in this exemplary embodiment, the operation other than the fast-forwarding and rewinding operations is the same as the classification result display operation by the data processing device 400 according to the fourth exemplary embodiment. The fast-forwarding and rewinding operations by the user interface part 653 of the data processing device 600 according to this exemplary embodiment will be described below.

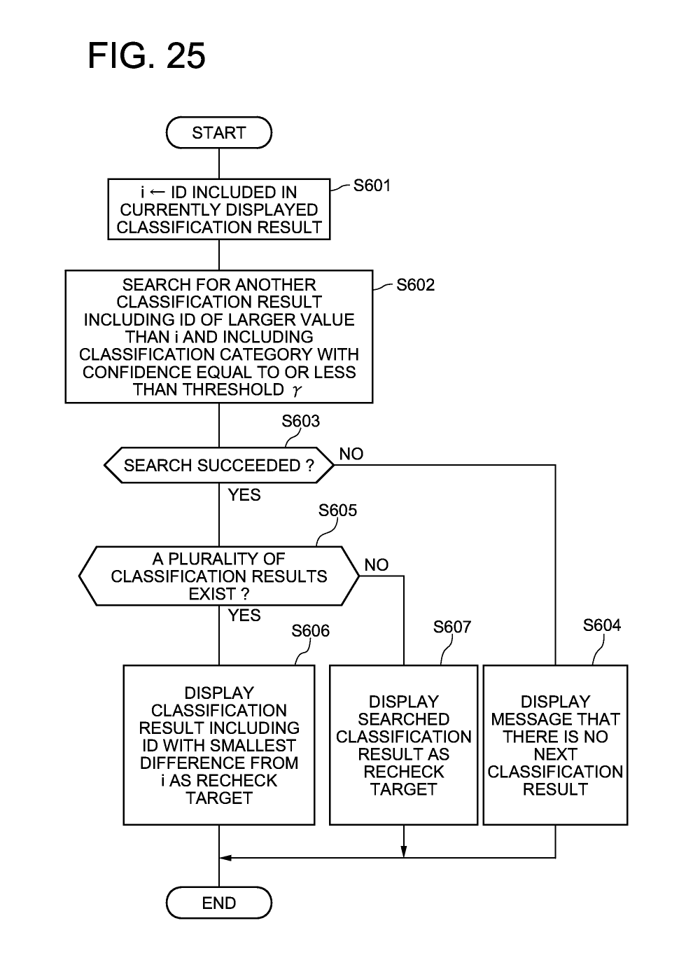

Firstly, referring to the flowchart of FIG. 25 showing an example of fast-forwarding by the user interface part 653, the fast-forwarding operation by the user interface part 653 of the data processing device 600 according to this exemplary embodiment will be described.

When a fast-forwarding instruction is inputted through the operation input part 620, the user interface part 653 of the data processing part 600 sets the ID (4441) included in the classification result 644 currently displayed by the screen display part 630 to a local variable i (step S601). Next, the user interface part 653 searches for another classification result 644 which includes an ID of a larger value than the ID having been set to the local variable i and which includes the classification category (4444) with the confidence (4445) equal to or less than the threshold γ, through the storage part 640 (step S602).

Next, the user interface part 653 checks whether or not the abovementioned search has succeeded (step S603). If failed, the user interface part 653 causes the screen display part 630 to display a message that a next classification result to recheck does not exist (step S604), and ends the fast-forwarding operation. On the other hand, in a case where the abovementioned search has succeeded, the user interface part 653 determines whether or not the number of the other classification results having been searched for is two or more (step S605). In a case where the number of the other classification results having been searched for is two or more, the user interface part 653 switches the display screen so that one classification result 644 including an ID with the smallest difference from the ID having been set to the local variable i among the other classification results becomes the recheck target (step S606). In other words, the user interface part 653 causes the classification result display screen of the screen display part 630 to display the ID (4441), the content (4442), the label (4443) and the classification category (4445) of the one classification result 644 (step S606). Meanwhile, in a case where the number of the other classification results having been searched for is one, the user interface part 653 causes the classification result display screen of the screen display part 630 to display the ID (4441), the content (4442), the label (4443) and the classification category (4445) of the classification result 444 having been searched for. Then, the user interface part 653 ends the fast-forwarding operation.

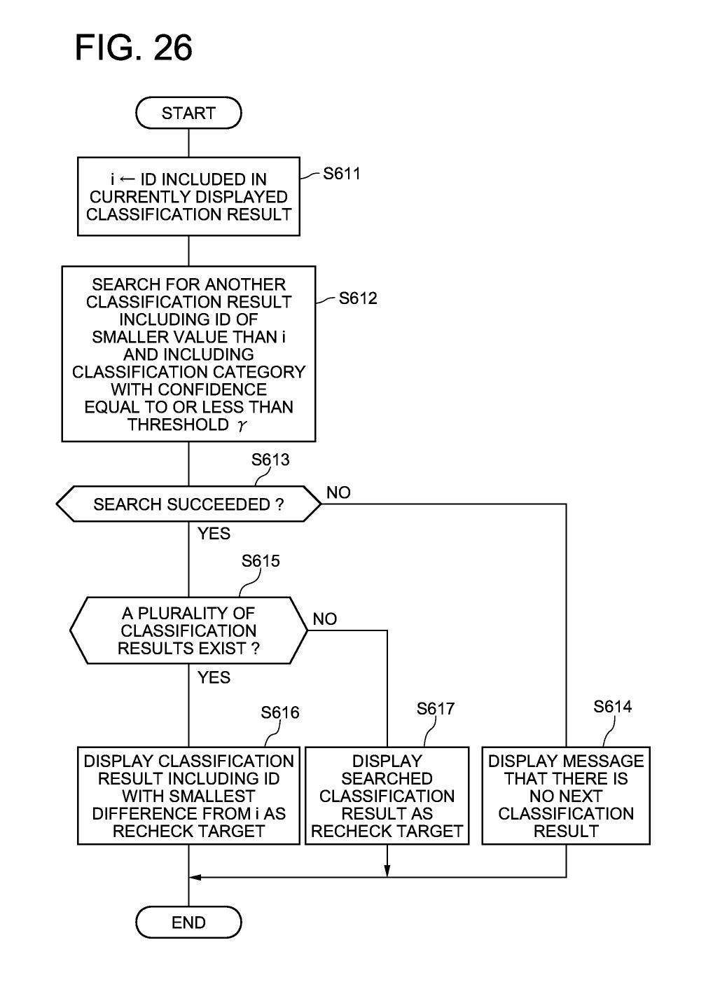

Next, referring to the flowchart of FIG. 26 showing an example of rewinding by the user interface part 653, the rewinding operation by the user interface part 653 of the data processing device 600 according to this exemplary embodiment will be described.

When a rewinding instruction is inputted through the operation input part 620, the user interface part 653 of the data processing part 600 sets the ID (4441) included in the classification result 644 currently displayed by the screen display part 630 to a local variable i (step S611). Next, the user interface part 653 searches for another classification result 644 which includes an ID with a smaller value than the ID having been set to the local variable i and which includes the classification category (4444) with the confidence (4445) equal to or less than the threshold γ, through the storage part 640 (step S612).

Next, the user interface part 653 checks whether or not the abovementioned search has succeeded (step S613). If failed, the user interface part 653 causes the screen display part 630 to display a message that a next classification result to recheck does not exist (step S614), and ends the rewinding operation. On the other hand, in a case where the abovementioned search has succeeded, the user interface part 653 determines whether or not the number of the other classification results having been searched for is two or more (step S615). In a case where the number of the other classification results have been searched for is two or more, the user interface part 653 switches the display screen so that one classification result 644 including an ID with the smallest difference from the ID having been set to the local variable i among the other classification results becomes the recheck target (step S616). In other words, the user interface part 653 causes the classification result display screen of the screen display part 630 to display the ID (4441), the content (4442), the label (4443) and the classification category (4445) of the one classification result 644 (step S616). Meanwhile, in a case where the number of the classification results have been searched for is one, the user interface part 653 causes the classification result display screen of the screen display part 630 to display the ID (4441), the content (4442), the label (4443) and the classification category (4445) of the classification result 644 having been searched for. Then, the user interface part 653 ends the rewinding operation.

Thus, according to this exemplary embodiment, it is possible to reduce the user's burden of rechecking adequacy of teacher data. The reason is as follows.

It is assumed that the plurality of teacher data 642 used for generation of the classification model 643 contain teacher data 642 generated by the user's struggle to determine a category and teacher data 642 having allowed the user to distinctly determine. In this case, the classification model 643 generated by using the plurality of teacher data 642 classifies the content of the teacher data 642 generated by the struggle to determine into a category which is the same as or different from a category indicated by the label of the teacher data 642, and the confidence in this case tends to be not very high. Moreover, the classification model 643 classifies the content of the teacher data 642 having allowed distinct determination into a category which is the same as a category indicated by the label of the teacher data 642, and the confidence in this case tends to be high. Moreover, the teacher data 642 having allowed the user to distinctly determine is less likely to be inadequate, whereas the teacher data 642 generated by the struggle to determine is likely to be inadequate. Accordingly, by executing the rechecking operation exclusively on the teacher data 642 that is likely to be inadequate, it is possible to reduce the user's burden without missing inadequate teacher data. Because this exemplary embodiment provides the fast-forwarding function and the rewinding function, the user can efficiently conduct a rechecking operation solely on the teacher data 642 that the confidence is equal to or less than the threshold γ.

### Seventh Exemplary Embodiment

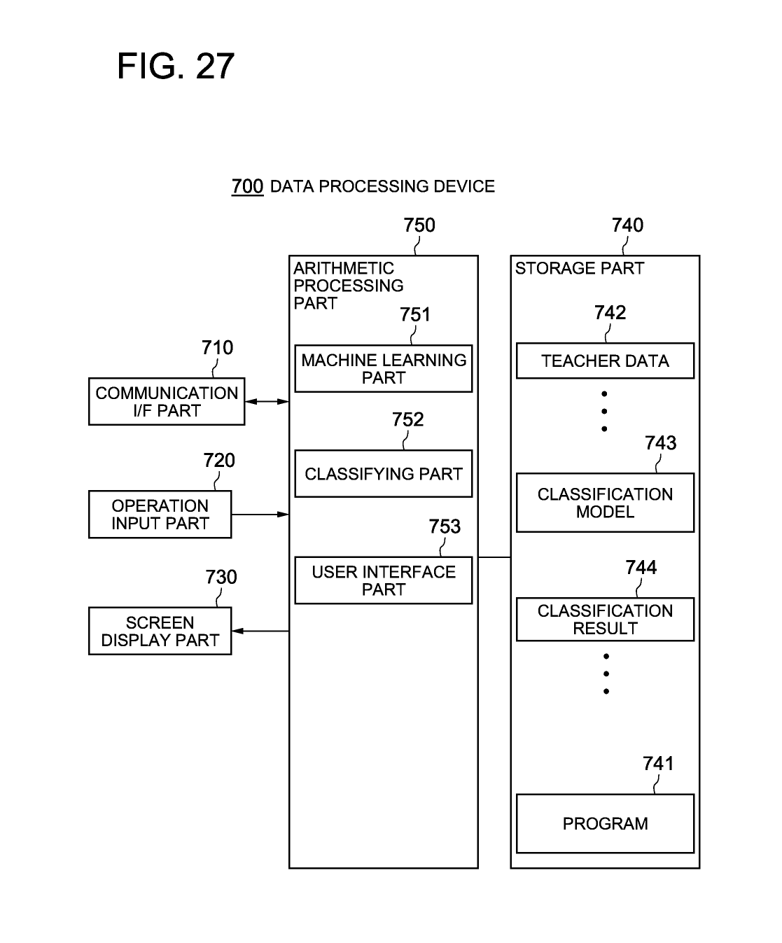

Referring to FIG. 27, a data processing device 700 according to a seventh exemplary embodiment of the present invention is different from the data processing device 400 according to the fourth exemplary embodiment of the present invention in that the data processing device 700 has a function to, in a case where there is no input of a check result at a time point that teacher data is displayed during a predetermined time while the user is rechecking the teacher data, consider that there is a check input representing no correction and proceed to a process of rechecking next teacher data.

This data processing device 700 has, as major functional parts, a communication I/F part 710, an operation input part 720, a screen display part 730, a storage part 740, and an arithmetic processing part 750. Among these parts, the communication I/F part 710, the operation input part 720 and the screen display part 730 have the same functions as the communication I/F part 410, the operation input part 420 and the screen display part 430 of the data processing device 400 according to the fourth exemplary embodiment of the present invention.

The storage part 740 is composed of a storage device such as a hard disk and a memory, and has a function to store processing information necessary for various kinds of processing in the arithmetic processing part 750 and a program 741. The program 741 is a program which realizes various kinds of processing parts when loaded in and executed by the arithmetic processing part 750. The program 741 is previously loaded from an external device (not shown in the drawings) or a storage medium (not shown in the drawings) via a data input/output function such as the communication I/F part 710 and stored into the storage part 740. Major processing information stored in the storage part 740 is a plurality of teacher data 742, a classification model 743, and a classification result 744. The plurality of teacher data 742, the classification model 743 and the classification result 744 are the same as the plurality of teacher data 442, the classification model 443 and the classification result 444 of the data processing device 400 according to the fourth exemplary embodiment of the present invention.

The arithmetic processing part 750 has a processor like a MPU and a peripheral circuit thereof, and has a function to load the program 741 from the storage part 740 and execute the program to make the hardware and the program 741 work in cooperation and realize various kinds of processing parts. Major processing parts realized by the arithmetic processing part 750 are a machine learning part 751, a classifying part 752, and a user interface part 753. Among these parts, the machine learning part 751 and the classifying part 752 have the same functions as the machine learning part 451 and the classifying part 452 of the data processing device 400 according to the fourth exemplary embodiment of the present invention.

The user interface part 753 has a function to load a plurality of classification results 744 from the storage part 740 and cause the screen display part 730 to display IDs (4421), contents (4422), labels (4443) and classification categories (4444) included in the classification results 644, and a function to accept an input of correction of the displayed label from the operation input part 720 and correct the label of the corresponding teacher data 742.

Further, the user interface part 753 has a function to, in the abovementioned display and the abovementioned correction, when the user interface part 753 has not accepted a correction input from the operation input part 720 at a time point that the content and label of certain teacher data and the classification category determined by the classifying part 752 have been displayed during a predetermined time, determine that correction is not required and cause the screen display part 730 to display the content and label of other teacher data stored in the storage part 740 and the classification category determined by the classifying part 752.

Further, the user interface part 753 has a function to, in the abovementioned display, determine the abovementioned predetermined time that the content and label of teacher data and a classification category are displayed by the screen display part 730 in accordance with the confidence of the classification category. To be specific, in the abovementioned determination of the predetermined time, the user interface part 753 determines the longer predetermined time as the confidence is lower. The longest time may be infinite length. In this case, the user interface part 753 keeps waiting for a check input from the user. The shortest time may be 0. In this case, the user interface part 753 omits (i.e., skips) the user's operation to recheck the teacher data.

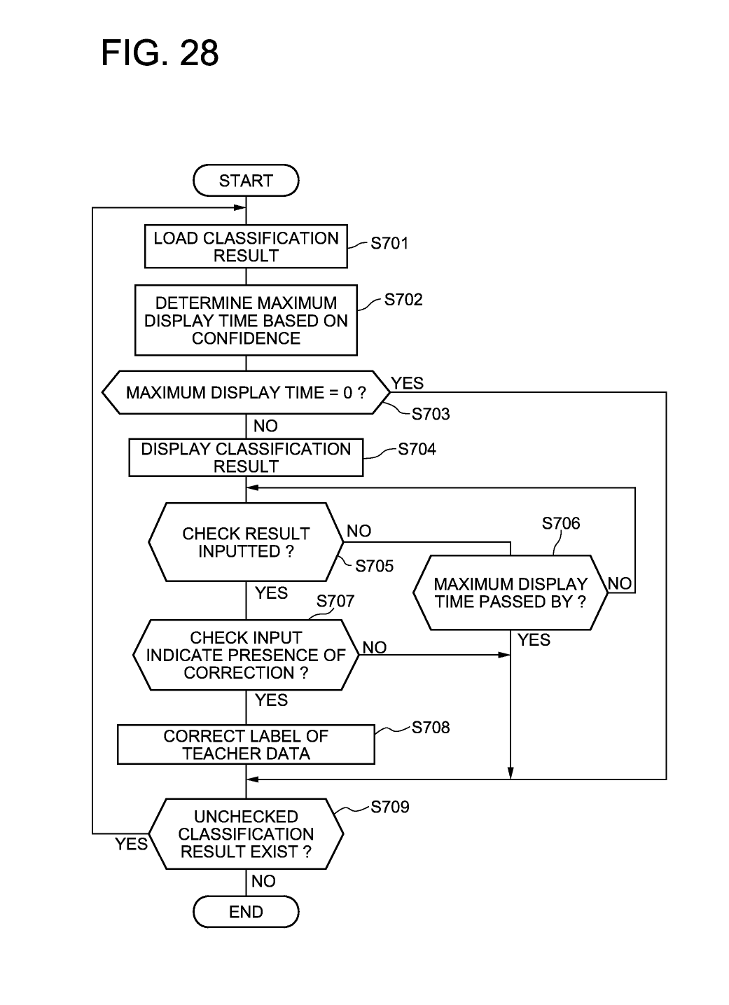

Next, the behavior of the data processing device 700 according to this exemplary embodiment will be described. A machine learning operation and a classification operation by the data processing device 700 according to this exemplary embodiment are the same as the machine learning operation and the classification operation by the data processing device 400 according to the fourth exemplary embodiment. A classification result display operation by the user interface part 753 of the data processing device 700 in this exemplary embodiment will be described below referring to the flowchart of FIG. 28 showing an example of processing by the user interface part 753.

When the user interface part 753 of the data processing device 700 is activated, firstly, the user interface part 753 loads one of the classification results 744 having not been displayed yet from the storage part 740 (step S701). Next, based on the confidence (4445) of the classification result 744, the user interface part 753 determines a maximum display time for making the user recheck this classification result (step S702).

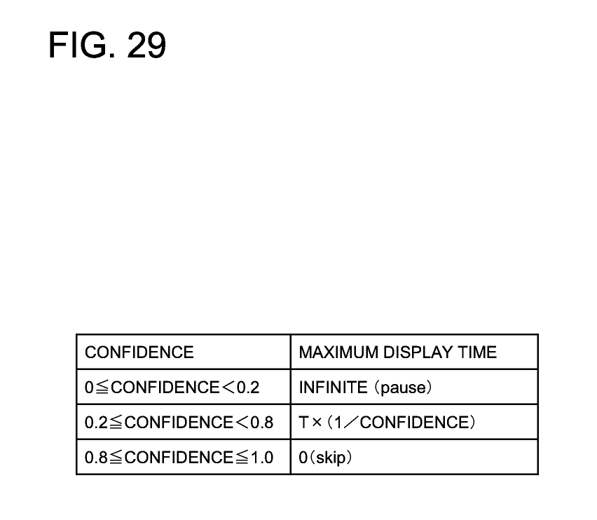

FIG. 29 shows an example of a table for determining the maximum display time based on the confidence. In this example, when the confidence is equal to or more than 0 and less than 0.2, the maximum display time is 0. Moreover, when the confidence is equal to or more than 0.8 and equal to or less than 1.0, the maximum display time is infinite. Moreover, when the confidence is equal to or more than 0.2 and less than 0.8, the maximum display time is calculated by T×confidence. Herein, T represents a fixed time determined in advance. The user interface part 753 holds the table shown in FIG. 29, and determines the maximum display time for each of the classification results 744 referring to this table.

Upon determination of the maximum display time, the user interface part 753 then determines whether or not the determined maximum display time is 0 (step S703). In a case where the maximum display time is not 0, the user interface part 753 causes the screen display part 730 to display the ID, content, label and classification category of the classification result 744 (step S704). Then, the user interface part 753 waits until a check result is inputted from the operation input part 720 or the maximum display time passes by (step S705, step S706).

When a check result is inputted from the operation input part 720 (Yes at step S705), the user interface part 753 determines whether the input indicates the absence of correction or the presence of a correction (step S707). Then, in a case where the input indicates the presence of a correction, the user interface part 753 searches for teacher data 742 having the same ID as the ID displayed by the screen display part 730 through the storage part 740, and updates the value of the label included in this searched teacher data 742 to a category inputted by the user (step S708). Then, the user interface part 753 proceeds to step S709. Moreover, in a case where the user has not instructed to correct the label (no correction at step S707), the user interface part 753 skips the step S708 and proceeds to step S709. On the other hand, the user interface part 753 considers that a check input indicating the absence of a correction is made by the user, and proceeds to step S709.

At step S709, the user interface part 753 checks whether or not a classification result 744 having not been checked by the user yet exists in the storage part 740. Then, in a case where the unchecked classification result 744 is still left, the user interface part 753 returns to the step S701 and repeats the same process as the abovementioned process. On the other hand, in a case where the unchecked classification result 744 is not left, the user interface part 753 ends the classification result display process.

Thus, according to this exemplary embodiment, for the same reason as in the first exemplary embodiment of the present invention, it is possible to reduce the user's burden of rechecking adequacy of teacher data.

Further, according to this exemplary embodiment, at the time of recheck of teacher data by the user, when there is no input of a check result at a time point that the teacher data has been displayed for a predetermined time, it is considered that a check input indicating the absence of correction is made and the process can be proceeded to a process of rechecking next teacher data. Therefore, it is possible to reduce the amount of the user's operation when correction is not required.

Further, according to this exemplary embodiment, the predetermined time is determined based on the confidence of a classification category, so that it is possible to control such as increase the recheck time in a situation that determination may take time and decrease the recheck time shorter in a situation that determination may be made in a short time.

### Other Exemplary Embodiments

Although the present invention is described above with some exemplary embodiments, the present invention is not limited to the abovementioned exemplary embodiments and can be modified and altered in various manners. For example, exemplary embodiments as described below are also included by the present invention.

In the abovementioned exemplary embodiments, a label which is necessary for generation of teacher data is inputted by using a keyboard and a mouse, but may be the following input forms.

A touchscreen part which detects a touch operation and outputs detection information is used, the direction of a flick is detected based on the detection information outputted by the touchscreen part, a label indicating a category to which content belongs is determined based on the detected flick direction, and teacher data having the content displayed by the display part and the determined label is generated.

Otherwise, an acceleration sensor part which detects a swing and outputs detection information is used, the direction of the swing is detected based on the detection information outputted by the sensor part, a label indicating a category to which content belongs is determined based on the detected direction of the swing, and teacher data having the content displayed by the display part and the abovementioned label is generated.

Otherwise, a tilt sensor part which detects a tilt and outputs detection information is used, the direction of the tilt is detected based on the detection information outputted by the sensor part, a label indicating a category to which content belongs is determined based on the detected direction of the tilt, and teacher data having the content displayed by the display part and the abovementioned label is generated.

Otherwise, a touchscreen part which detects a touch operation and outputs detection information is used, the kind of a gesture is detected based on the detection information outputted by the touchscreen part, a label indicating a category to which content belongs is determined based on the detected kind of the gesture, and teacher data having the content displayed by the display part and the abovementioned label is generated.

### INDUSTRIAL APPLICABILITY

The present invention can be utilized for generation of teacher data in the fields of video monitoring, video analysis, and the like.

1. A data processing device comprising:
a storage part storing a plurality of teacher data including respective contents and respective labels, the labels representing categories to which the contents belong;
a machine learning part generating a classification model by using the plurality of teacher data;
a classifying part determining a category to which a content of each of the plurality of teacher data belongs, by using the classification model; and
a user interface part causing a display part to display the content and a label of each of the plurality of teacher data and the category that the content belongs determined by the classifying part.

2. The data processing device according to claim 1, wherein the user interface part accepts an input of correction for the displayed label of the teacher data, and corrects the label of the teacher data in accordance with the accepted input of correction.

3. The data processing device according to claim 1, wherein the user interface part extracts teacher data in which the category represented by the label is different from the category determined by the classifying part, from among the plurality of teacher data stored in the storage part, and causes the display part to display the content and the label of the extracted teacher data and the category that the content belongs determined by the classifying part.

4. The data processing device according to claim 1, wherein:
the classifying part determines the category that the content of each of the plurality of teacher data belongs, and also calculates confidence that the teacher data belongs to the determined category; and
the user interface part extracts teacher data in which the confidence of the category determined by the classifying part is equal to or less than a threshold, from among the plurality of teacher data stored in the storage part, and causes the display part to display the content and the label of the extracted teacher data and the category that the content belongs determined by the classifying part.

5. The data processing device according to claim 1, wherein:
the classifying part determines the category that the content of each of the plurality of teacher data belongs, and also calculates confidence that the teacher data belongs to the determined category; and
the user interface part invalidates teacher data in which the confidence of the category determined by the classifying part is equal to or less than a threshold, among the plurality of teacher data stored in the storage part.

6. The data processing device according to claim 1, wherein:
the classifying part determines the category that the content of each of the plurality of teacher data belongs, and also calculates confidence that the teacher data belongs to the determined category; and
when a fast-forwarding instruction or a rewinding instruction is inputted while the display part is displaying the content and the label of one of the plurality of teacher data and the category that the content belongs determined by the classifying part, the user interface part causes the display part to display the content and the label of one of rest of the plurality of teacher data stored in the storage part and the category that the content belongs determined by the classifying part, the one of the rest of the plurality of teacher data being teacher data in which the confidence of the category determined by the classifying part is equal to or less than a threshold.

7. The data processing device according to claim 2, wherein, in a case where the input of correction is not accepted at a time point that the display part displays the content and the label of one of the plurality of teacher data and the category that the content belongs determined by the classifying part for a predetermined time, the user interface part determines correction is unnecessary, and causes the display part to display the content and the label of one of rest of the plurality of teacher data stored in the storage part and the category that the content belongs determined by the classifying part.

8. The data processing device according to claim 7, wherein:
the classifying part determines the category that the content of each of the plurality of teacher data belongs, and also calculates confidence that the teacher data belongs to the determined category; and
the user interface part determines the predetermined time to cause the display part to display the content and the label of the teacher data and the category that the content belongs determined by the classifying part, in accordance with the confidence.

9. The data processing device according to claim 8, wherein the user interface part determines the predetermined time to be longer as the confidence is lower.

10. The data processing device according to claim 1, comprising a teacher data generating part generating the plurality of teacher data,
wherein the teacher data generating part: inputs frame images of a moving image and causes the display part to display the frame images in frame order; accepts input of the category that each of the frame images displayed by the display part belongs from an input part; and generates the teacher data including the frame image as the content and the label representing the accepted input of the category and stores the teacher data into the storage part.

11. The data processing device according to claim 10, wherein the teacher data generating part: detects one teacher data and other one teacher data from among the plurality of teacher data stored in the storage part, the one teacher data including the label representing one of the categories, the other one teacher data including as the content the frame image immediately after the frame image representing the content included in the one teacher data, and the other one teacher data including the label representing a different category from the category represented by the label of the one teacher data; and invalidates the detected one teacher data and the detected other one teacher data.

12. The data processing device according to claim 10, wherein the teacher data generating part: detects one teacher data and other teacher data from among the plurality of teacher data stored in the storage part, the one teacher data including the label representing one of the categories, the other one teacher data including as the content the frame image immediately after the frame image representing the content included in the one teacher data, and the other one teacher data including the label representing a different category from the category represented by the label of the one teacher data; and invalidates the teacher data including as the content the frame image belonging to a period from time of the frame image of the detected other one teacher data to time a predetermined time back to the past, and the teacher data including as the content the frame image belonging to a period from time of the frame image of the detected one teacher data to time the predetermined time later.

13. A data processing method executed by a data processing device including a storage part storing a plurality of teacher data including respective contents and respective labels, the labels representing categories to which the contents belong, the data processing method comprising:
generating a classification model by using the plurality of teacher data;
determining a category to which a content of each of the plurality of teacher data belongs, by using the classification model; and
causing a display part to display the content and a label of each of the plurality of teacher data and the determined category that the content belongs.

14. The data processing method according to claim 13, comprising:
accepting an input of correction for the displayed label of the teacher data, and correcting the label of the teacher data in accordance with the accepted input of correction.

15. The data processing method according to claim 13, comprising:
in the display, extracting teacher data in which the category represented by the label is different from the determined category, from among the plurality of teacher data stored in the storage part, and causing the display part to display the content and the label of the extracted teacher data and the determined category that the content belongs.

16. The data processing method according to claim 13, comprising;
in the determination of the category, determining the category that the content of each of the plurality of teacher data belongs, and also calculating confidence that the teacher data belongs to the determined category; and
in the display, extracting teacher data in which the confidence of the determined category is equal to or less than a threshold, from among the plurality of teacher data stored in the storage part, and causing the display part to display the content and the label of the extracted teacher data and the determined category that the content belongs.

17. The data processing method according to claim 13, comprising:
in the determination of the category, determining the category that the content of each of the plurality of teacher data belongs, and also calculating confidence that the teacher data belongs to the determined category; and
in the display, invalidating teacher data in which the confidence of the determined category is equal to or less than a threshold, among the plurality of teacher data stored in the storage part.

18. The data processing method according to claim 13, comprising:
in the determination of the category, determining the category that the content of each of the plurality of teacher data belongs, and also calculating confidence that the teacher data belongs to the determined category; and
in the display, when a fast-forwarding instruction or a rewinding instruction is inputted while the display part is displaying the content and the label of one of the plurality of teacher data and the determined category that the content belongs, causing the display part to display the content and the label of one of rest of the plurality of teacher data stored in the storage part and the determined category that the content belongs, the one of the rest of the plurality of teacher data being teacher data in which the confidence of the determined category is equal to or less than a threshold.

19. The data processing method according to claim 14, comprising:
in the display and the correction, in a case where the input of correction is not accepted at a time point that the display part displays the content and the label of one of the plurality of teacher data and the determined category that the content belongs for a predetermined time, determining correction is unnecessary, and causing the display part to display the content and the label of one of rest of the plurality of teacher data stored in the storage part and the determined category that the content belongs.

20. The data processing method according to claim 19, comprising:
in the determination of the category, determining the category that the content of each of the plurality of teacher data belongs, and also calculating confidence that the teacher data belongs to the determined category; and
in the display, determining the predetermined time to cause the display part to display the content and the label of the teacher data and the determined category that the content belongs, in accordance with the confidence.

21. The data processing method according to claim 20, comprising:
in the determination of the predetermined time, determining the predetermined time to be longer as the confidence is lower.

22. The data processing method according to claim 13, comprising:
generating the plurality of teacher data; and
in the generation of the teacher data: inputting frame images of a moving image and causing the display part to display the frame images in frame order; accepting input of the category that each of the frame images displayed by the display part belongs from an input part; and generating the teacher data including the frame image as the content and the label representing the accepted input of the category and storing the teacher data into the storage part.

23. The data processing method according to claim 22, comprising:
in the generation of the teacher data: detecting one teacher data and other one teacher data from among the plurality of teacher data stored in the storage part, the one teacher data including the label representing one of the categories, the other one teacher data including as the content the frame image immediately after the frame image representing the content included in the one teacher data, and the other one teacher data including the label representing a different category from the category represented by the label of the one teacher data; and invalidating the detected one teacher data and the detected other one teacher data.

24. The data processing method according to claim 22, comprising:
in the generation of the teacher data: detecting one teacher data and other teacher data from among the plurality of teacher data stored in the storage part, the one teacher data including the label representing one of the categories, the other one teacher data including as the content the frame image immediately after the frame image representing the content included in the one teacher data, and the other one teacher data including the label representing a different category from the category represented by the label of the one teacher data; and invalidating the teacher data including as the content the frame image belonging to a period from time of the frame image of the detected other one teacher data to time a predetermined time back to the past, and the teacher data including as the content the frame image belonging to a period from time of the frame image of the detected one teacher data to time the predetermined time later.

25. A non-transitory computer-readable medium storing a program comprising instructions for causing a computer to function as, the computer including a storage part storing a plurality of teacher data including respective contents and respective labels, and the labels representing categories to which the contents belong:
a machine learning part generating a classification model by using the plurality of teacher data;
a classifying part determining a category to which a content of each of the plurality of teacher data belongs, by using the classification model; and
a user interface part causing a display part to display the content and a label of each of the plurality of teacher data and the category that the content belongs determined by the classifying part.
